(19) United States
(12) Patent Application Publication
(10) Pub. No.: US 2017/0230236 A1
(43) Pub. Date: Aug. 10, 2017

(54) FUNCTION SYNCHRONIZATION METHOD AND ELECTRONIC DEVICE FOR SUPPORTING THE SAME

(71) Applicant: Samsung Electronics Co., Ltd., Gyeonggi-do (KR)

(72) Inventors: Sung Dong KIM, Gyeonggi-do (KR); Gyu Bong OH, Gyeonggi-do (KR); Jong Hyun JIN, Gyeonggi-do (KR); Soon Hyun CHA, Gyeonggi-do (KR)

(21) Appl. No.: 15/422,682

(22) Filed: Feb. 2, 2017

(30) Foreign Application Priority Data
Feb. 4, 2016 (KR) 10-2016-0014100

(51) Int. Cl. H04L 12/24; H04L 7/00

(52) U.S. Cl. CPC H04L 41/08; H04L 7/0008

(57) ABSTRACT

A method and an electronic device implementing the same are disclosed. The electronic device includes a memory configured to store synchronization configuration information associated with function synchronization with an external electronic device and a processor. The processor executes the method, including storing, by memory, synchronization configuration information for implementing function synchronization with at least one external electronic device, controlling the electronic device by a processor to transmit synchronization configuration information to a server, the synchronization configuration information generated according to settings, each indicating whether to synchronize at least one function of a plurality of functions, and in response to detecting a change to at least one of the plurality of functions, transmitting change information indicating the change to the server.

### CLAIM OF PRIORITY

This application claims the benefit under 35 U.S.C. §119(a) of a Korean patent application filed on Feb. 4, 2016 in the Korean Intellectual Property Office and assigned Serial number 10-2016-0014100, the entire disclosure of which is hereby incorporated by reference.

### TECHNICAL FIELD

The present disclosure relates to function synchronization.

### BACKGROUND

In general, an electronic device performs a variety of functions. For example, the electronic device performs a communication function based on at least one communication mode. Further, the electronic device may support a sleep mode or a mode of executing a specified function based on a user input or settings.

A user may operate a plurality of electronic device simultaneously, sequentially, or selectively in various manners. Thus, the user who uses the plurality of conventional electronic devices may separately set a function state suitable for his or her intention with respect to each of the plurality of electronic devices.

### SUMMARY

Aspects of the present disclosure are to address at least the above-mentioned problems. Accordingly, an aspect of the present disclosure is to provide a function synchronization method for synchronizing functions of a plurality of specified electronic devices and operating specified functions in an integrated manner without separate setting for the plurality of electronic devices and an electronic device for supporting the same.

In accordance with an aspect of the present disclosure, an electronic device is disclosed, including a memory configured to store synchronization configuration information associated with function synchronization with an external electronic device, and a processor, operatively connected to the memory. The processor implements transmitting synchronization configuration information to a server, the synchronization configuration information generated according to settings, each indicating whether to synchronize at least one function of a plurality of functions, and in response to detecting a change to at least one of the plurality of functions, transmitting change information indicating the change to the server.

In accordance with another aspect of the present disclosure, a function synchronization method is provided, including storing, by memory, synchronization configuration information for implementing function synchronization with at least one external electronic device, controlling the electronic device by a processor to transmit synchronization configuration information to a server, the synchronization configuration information generated according to settings, each indicating whether to synchronize at least one function of a plurality of functions, and in response to detecting a change to at least one of the plurality of functions, transmitting change information indicating the change to the server

Other aspects and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a signal sequence diagram illustrating an example of a system associated with function synchronization according to an embodiment of the present disclosure;

FIG. 2 is a block diagram illustrating an example of a function synchronization system according to an embodiment of the present disclosure;

FIG. 3 is a block diagram illustrating an example of function modules based on a processor or a memory according to an embodiment of the present disclosure;

FIG. 4 is a flowchart illustrating a method for operating an electronic device associated with function synchronization according to an embodiment of the present disclosure;

FIG. 5 is a block diagram illustrating an example of a server according to an embodiment of the present disclosure;

FIG. 6 is a flowchart illustrating a method for operating a server associated with function synchronization according to an embodiment of the present disclosure;

FIG. 7 is a flowchart illustrating a method for operating an external electronic device associated with function synchronization according to an embodiment of the present disclosure;

FIG. 8 is a drawing illustrating an example of a screen interface of an electronic device associated with setting function synchronization according to an embodiment of the present disclosure;

FIG. 9 is a drawing illustrating an example of a screen interface of an external electronic device associated with function synchronization according to an embodiment of the present disclosure;

FIG. 10 is a drawing illustrating an example of a screen interface associated with selecting a detailed function of an electronic device associated with function synchronization according to an embodiment of the present disclosure;

FIG. 11 is a drawing illustrating an example of a screen interface of an electronic device associated with applying function synchronization according to an embodiment of the present disclosure;

FIG. 12 is a drawing illustrating an example of a screen interface of an external electronic device associated with applying function synchronization according to an embodiment of the present disclosure;

FIG. 13 is a block diagram illustrating a configuration of an electronic device according to various embodiments; and

FIG. 14 is a block diagram illustrating a configuration of a program module according to various embodiments.

Throughout the drawings, it should be noted that like reference numbers are used to depict the same or similar elements, features, and structures.

### DETAILED DESCRIPTION

Various embodiments of the present disclosure may be described with reference to accompanying drawings. Accordingly, those of ordinary skill in the art will recognize that modification, equivalent, and/or alternative on the various embodiments described herein can be variously made without departing from the present disclosure. With regard to description of drawings, similar elements may be marked by similar reference numerals.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments, but do not limit the elements. Furthermore, such terms may be used to distinguish one element from another element. For example, “a first user device” and “a second user device” may indicate different user devices regardless of the order or priority thereof. For example, “a first user device” and “a second user device” indicate different user devices.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” is not limited to meaning “specifically designed to” in hardware. Instead, the expression “a device configured to” may mean that the device is “capable of” operating together with another device or other components. CPU, for example, a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

Terms used in the present disclosure are used to describe specified embodiments and are not intended to limit the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, e-book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart watches, and the like.

According to another embodiment, the electronic devices may be home appliances. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, or the like.

According to another embodiment, the photographing apparatus may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to another embodiment, the electronic devices may include at least one of parts of furniture or buildings/structures, electronic boards, electronic signature receiving devices, projectors, or various measuring instruments (e.g., water meters, electricity meters, gas meters, or wave meters, and the like). In the various embodiments, the electronic device may be one of the above-described various devices or a combination thereof. An electronic device according to an embodiment may be a flexible device. Furthermore, an electronic device according to an embodiment may not be limited to the above-described electronic devices and may include other electronic devices and new electronic devices according to the development of technologies.

Hereinafter, an electronic device according to the various embodiments may be described with reference to the accompanying drawings. The term “user” used herein may refer to a person who uses an electronic device or may refer to a device (e.g., an artificial intelligence electronic device) that uses an electronic device.

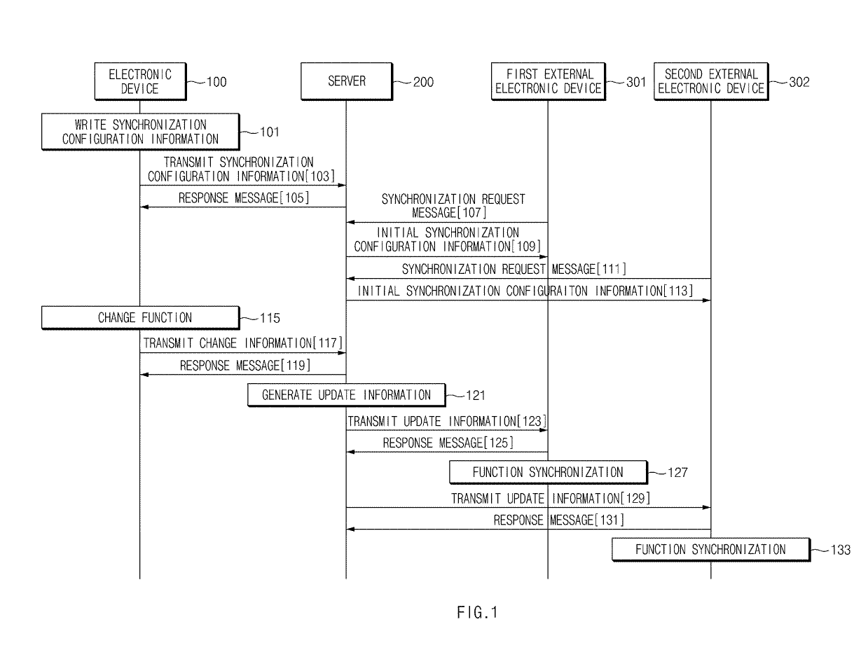

FIG. 1 is a signal sequence diagram illustrating an example of a system associated with function synchronization according to an embodiment of the present disclosure.

Referring to FIG. 1, the system associated with the function synchronization may include an electronic device 100, a server 200, and at least one external electronic device 301 and/or 302. The server 200 may provide a default setting profile (e.g., a synchronization configuration information form) for an environment setup of the electronic device 100. The electronic device 100 may perform initial setup (e.g., may write synchronization configuration information) to receive a server for sharing a state with external electronic devices. The electronic device 100 may change a profile corresponding to the synchronization configuration information based on a user input. In this operation, the electronic device 100 may set a user preference for changing a setting with the first and second external electronic devices 301 and 302 (or an external electronic device group). For example, the electronic device 100 may provide a user preference indicating whether to perform synchronization. Hereinafter, a description will be given of an example in which the electronic device 100 is a “master” device and initiates an environment setup associated with function synchronization, and in which the first and second external electronic devices 301 and 302 are “slave” terminals which perform the function synchronization in response to control of the electronic device 100.

In operation 101, the electronic device 100 may write a synchronization configuration information (e.g., a device setting profile (DSP) registration message) associated with the function synchronization. In this regard, the electronic device 100 may access the specified server 200 providing a synchronization configuration information form, request the server 200 to transmit the synchronization configuration information form (e.g., a DSP message) provided by a default setting, and receive the corresponding message from the server 200. Alternatively, the electronic device 100 may generate synchronization configuration information associated with the function synchronization, based on a synchronization configuration information form stored in memory. The synchronization configuration information may include information about a list of synchronizations supported by the electronic device 100 and state information of the electronic device 100 associated with each synchronization list (e.g., information for enabling or disabling at least one synchronization function). Also, the synchronization configuration information may include identification information of the electronic device 100, information utilized for establishing a communication channel, or the like. The electronic device 100 may generate the synchronization configuration information in the form of an extensible markup language (XML) document. When generating the synchronization configuration information, the electronic device 100 may provide a service application rule for each function. The functions may include, for example, at least one of a long term evolution (LTE) function, a wireless-fidelity (Wi-Fi) function, an airplane environment function, a sleep environment function, a “manner” environment function, or a roaming environment function.

According to various embodiments, the synchronization configuration information may include a setting directory of the electronic device 100. The setting directory may include, for example, at least one of a setting profile of the electronic device 100 for each function, a wearable device list, a home appliances list, or a master device list. Also, the setting directory may include at least one of a setting profile which is currently executing on a master device (or a master terminal) (e.g., the electronic device 100), a setting profile rule according to a change in a function of the master device, a setting profile which is being run on a “slave” device (e.g., a slave terminal) (e.g., the first and second external electronic devices 301 and 302), or a list of terminals to which a setting profile of the master device is applied among the slave devices.

In operation 103, the electronic device 100 may transmit the synchronization configuration information to the specified server 200. For example, the electronic device 100 may transmit synchronization configuration information (e.g., a “DSP” registration information) to the server 200 in the form of a hypertext transfer protocol (HTTP) PUT message. According to various embodiments, the electronic device 100 may request an XML document management (XDM) server to register XML document information (e.g., a DSP) in an XDM server. The server 200 may support function synchronization, and/or an instant messaging service (IMS). According to an embodiment, the server 200 may be a presence server or a server administrating a user profile in an IMS. The server 200 may support functions such as providing a synchronization configuration information form, managing synchronization configuration information provided from the electronic device 100, monitoring a change in a function of the electronic device 100 or receiving change information associated with the change in the function from the electronic device 100, updating information based on the received change information and transmitting the updated information to at least one registered external electronic device, and the like, in connection with supporting function synchronization according to an embodiment.

In operation 105, the server 200 may transmit a specified message, for example, a response message (e.g., an “OK” message from server 200) to the electronic device 100 in response to receiving the synchronization configuration information. According to an embodiment, if receiving a DSP registration message from the electronic device 100, the server 200 may transmit a response message (e.g., an “OK” message from server 200) to the reception of the DSP registration message to the electronic device 100.

In operation 107, the first external electronic device 301 may transmit a synchronization request message (e.g., a session initiation protocol “SIP” SUBSCRIBE message) to the specified server 200. In this regard, if the first external electronic device 301 successfully accesses the server 200, the server 200 may provide a list of electronic devices which may be synchronized with the first external electronic device 301 to the first external electronic device 301. The first external electronic device 301 may automatically transmit a synchronization request message to the server 200 in response to detecting selection of an electronic device item. According to various embodiments, the first external electronic device 301 may registered with the same account as the electronic device 100 in a specific server. When the first external electronic device 301 accesses the server 200, the server 200 may transmit a list of other electronic devices which belong to the same account to the first external electronic device 301. According to an embodiment, the first external electronic device 301 may transmit a “DSP SUBSCRIBE” request message to the server 200 in connection with a synchronization request.

In operation 109, the server 200 may transmit initial synchronization configuration information (e.g., an “SIP NOTIFY” message) registered by the electronic device 100 to the first external electronic device 301 in response to receiving the synchronization request message. For example, the server 200 may transmit an initial DSP NOTIFY message corresponding to a DSP REGISTER message registered by the electronic device 100 to the first external electronic device 301.

According to an embodiment, in operation 111, the second external electronic device 302 may transmit a synchronization request message (e.g., a DSP SUBSCRIBE request message or an SIP SUBSCRIBE message) to the server 200. Also, in operation 113, the server 200 may transmit initial synchronization configuration information (e.g., an initial DSP NOTIFY message or an SIP NOTIFY message) to the second external electronic device 302. The synchronization request process of the second external electronic device 302 may include the same operation as the above-mentioned first external electronic device 301. Alternatively, if the second external electronic device 302 has an account different from the electronic device 100, the server 200 may provide a list of at least one electronic device which may be selected for synchronization by the second external electronic device 302 to the second external electronic device 302. In this operation, the server 200 may obtain location information of the second external electronic device 302 and may provide a list of electronic devices which register synchronization configuration information among electronic devices located within a range from a location of the second external electronic device 302 to the second external electronic device 302. An operation of each of external electronic devices, for transmitting the synchronization request message and receiving initial synchronization configuration information, may be performed irrespective of a type or order of each of the external electronic devices.

According to an embodiment, in operation 115, the electronic device 100 may change a function based on a user input or a scheduled setting. In this operation, the electronic device 100 may output a list of at least one synchronization function. Alternatively, if a specific function set on the function synchronization list is changed based on a user input or without a user input, such as by set time scheduling, the electronic device 100 may output and/or display guide information associated with the changed synchronization function. Alternatively, if a condition is detected indicating automatic changing of the synchronization function, the electronic device 100 may transmit a request the server 200 to verify the change in a function, and may change the synchronization function or maintain a previous function state based on a user input.

In operation 117, the electronic device 100 may transmit change information (e.g., presence information, such as for example, an SIP PUBLISH message) to the server 200 in response to the change in the function. For example, the electronic device 100 may change a communication mode from a long term evolution (LTE) mode (e.g., a previously performed communication function) to a Wi-Fi mode (e.g., a communication function changed based on a location or the arrival of a specified time) in response to an input signal for requesting to change the communication mode. In this regard, the electronic device 100 may activate its Wi-Fi communication module and may perform signaling associated with data communication based on the enabled Wi-Fi communication module. If a function is changed, the electronic device 100 may verify whether the changed function is included in a synchronization function list. If the changed function is included in the synchronization function list, the electronic device 100 may change synchronization configuration information based on the change in the function. The electronic device 100 may generate change information corresponding to the change of the synchronization configuration information and may transmit the generated change information to the server 200.

In operation 119, the server 200 may transmit a response message (e.g., an “OK” message from server 200) in response to receiving the change information from the electronic device 100. If the response message is not received from the server 200 within a specified time, the electronic device 100 may retransmit the change information to the server 200. The above-mentioned operation may be repeatedly performed a specified number of times within a specified time. If the change information is not acknowledged as received by the server 200, the electronic device 100 may output a guide message indicating a failure in transmitting the corresponding change information.

In operation 121, the server 200 may update information based on the change in the function of the electronic device 100, generating update information in response to the update of the information. For example, the server 200 may change a DSP corresponding to the synchronization configuration information and may change contents of a DSP directory file included in the DSP based on a DSP rule (e.g., change a profile to be applied, included in the first and second electronic devices 301 and 302). The server 200 may generate update information to be transmitted to the at least one external electronic devices 301 and 302, based on the changed contents of the DSP directory file. In this operation, the server 200 may update a DSP directory file associated with the first and second external electronic devices 301 and 302 based on a specified DSP rule.

In operation 123, the server 200 may transmit the update information to the first external electronic device 301, such as, for example, the first external electronic device 301 may receive an SIP NOTIFY message. In operation 125, the first external electronic device 301 may transmit a response message in response to receiving the update information to the server 200. In operation 127, the first external electronic device 301 may change its function based on the update information. For example, the first external electronic device 301 may change a currently set LTE communication mode to a Wi-Fi communication mode.

In operation 129, the server 200 may transmit the update information to the second external electronic device 302 (or the second external electronic device 302 may receive an SIP NOTIFY message). In operation 131, the second external electronic device 302 may transmit a response message in response to receiving the update information to the server 200. In operation 133, the second external electronic device 302 may change its function based on the update information. For example, the second external electronic device 302 may change a currently set LTE communication mode to a Wi-Fi communication mode.

The operations of the server 200, which transmit the update information to the first external electronic device 301 and the second external electronic device 302, may be simultaneously performed. Alternatively, the operation of transmitting the update information to the second external electronic device 302 may be performed sequentially with the operation of transmitting the update information to the first external electronic device 301.

If the electronic device 100 and the first and second external electronic devices 301 and 302 are electronic devices which utilize an internet protocol multimedia subsystem (IMS) service, they may register a function synchronization service based on the IMS service. In this regard, at least one of the electronic device 100 or the first and second external electronic devices 301 and 302 may use an IMS REGISTER message like Table 1 below.

TABLE 1

| | |
|---|---|
| SIP | REGISTER sip:registrar.rcsnetworkA.com SIP/2.0 |
| Register | Via: SIP/2.0/UDP bobspc.biloxi.com:5060;branch=z9hG4bKnashds7 |
| | Max-Forwards: 70 |
| | To: Bob sip:bob@rcsnetworkA.com |
| | From: Bob <sip:bob@rcsnetworkA.com>;tag=456248 |
| | User-Agent: RCS-client/RCS5.2 ABC-phone1000/v1.01 |
| | Call-ID: 843817637684230@998sdasdh09 |
| | CSeq: 1826 REGISTER |
| | Contact: <sip:RCS-ClientA@RCSClientA.rcsnetworkA.com>; |
| | +g.gsma.rcs.telephony=cs,volte;+g.oma.sip- |
| | im;+g.samsaung.telephony=modesync |
| | Expires: 7200 |
| | Content-Length: 0 |

As shown in Table 1, the electronic device 100 may use a device state sharing service between a plurality of devices by registering the feature tag “+g.samsaung.telephony=modesync” in an IMS. If the first and second external electronic devices 301 and 302 are terminals for supporting a non-IMS function, the server 200 may transmit a port-direct short message service (SMS) message to the first and second external electronic devices 301 and 302 such that a related port and application of each of the first and second external electronic devices 301 and 302 receives the SMS message. When receiving the SMS message, the first and second external electronic devices 301 and 302 may execute IMS registration to be synchronized with the server 200.

According to various embodiments, in the above-mentioned function synchronization system, in connection with setting a network of the electronic device 100, the electronic device 100 may perform an operation associated with a specific function (e.g., an LTE data connection or a Wi-Fi connection function).

For example, the setting of the network of the electronic device 100 is changed from an LTE mode to a Wi-Fi mode, the electronic device 100 may change changed details to a terminal setting profile by reflecting the changed details in a profile or presence information of a user of the electronic device 100. Table 2 may include presence information transmitted to the server 200 when the setting of the network of the electronic device 100 is changed to the Wi-Fi mode.

TABLE 2

| | |
|---|---|
| Presence | <?xml version=“1.0” encoding=“UTF-8”?> |
| information | <presence xmlns=“urn:ietf:params:xml:ns:pidf” |
| | xmlns:pdm=“urn:ietf:params:xml:ns:pidf:data-model” |
| | xmlns:rpid=“urn:ietf:params:xml:ns:pidf:rpid” |
| | xmlns:op=“urn:oma:xml:prs:pidf:oma-pres” |
| | xmlns:xsi=“http://www.w3.org/2001/XMLSchema-instance” |
| | entity=“sip:someone@example.com”> |
| | <tuple id=“a1232”> |
| | <status> |
| | <basic>open</basic> |
| | </status> |
| | <op:willingness> |
| | <op:basic>open</op:basic> |
| | </op:willingness> |
| | <op:session-participation> |
| | <op:basic>closed</op:basic> |
| | </op:session-participation> |
| | <op:registration-state>active</op:registration-state> |
| | <op:barring-state>terminated</op:barring-state> |
| | <op:service-description> |
| | <op:service-id>org.openmobilealliance:RCS-Session</op:service-id> |
| | <op:version>1.0</op:version> |
| | </op:service-description> |
| | </tuple> |
| | <pdm:device id=“a1233”> |
| | <pdm:deviceID>urn:uuid:48662e19-5fbf-43fc-a2fd- |
| | d23002787599</pdm:deviceID> |
| | <pdm:deviceWiFi>active</pdm:deviceWiFi> |
| | <pdm:deviceAirplane>inactive</pdm:deviceAirplane> |
| | <pdm:deviceSleep>inactive</pdm:deviceSleep> |
| | <pdm:deviceManner>inactive</pdm:deviceManner> |
| | <pdm:timestamp>2008-10-28T16:25:56Z</pdm:timestamp> |
| | </pdm:device> |
| | </presence> |

As shown in Table 2, the presence information transmitted to the server 200 by the electronic device 100 may include <deviceID> indicating state information of the electronic device 100, that is, a device identifier (ID), <deviceWiFi> indicating whether a device is in a Wi-Fi state, <deviceAirplane> indicating whether the device is in an airplane mode, <deviceSleep> indicating whether the device is in a sleep mode, <deviceManner> indicating whether the device is in a manner mode, and <time stamp> indicating time information, as well as information about a session in which the user participates.

The server 200 may determine that a network setting is changed to the Wi-Fi mode from a profile or presence information of the user and may verify a user preference about whether to perform synchronization for a network setting between the electronic device 100 and the first and second external electronic devices 301 and 302 (or an external electronic device group).

The user preference may be basically stored in an XDM server. If a master device (e.g., the electronic device 100) notifies the server 200 of a state where it is changed from a specific mode to the Wi-Fi mode, the server 200 may verify the user preference about whether to perform synchronization for the network setting between the electronic device 100 and the first and second external electronic devices 301 and 302 and may perform processing (or controlling) such that the first and second external electronic devices 301 and 302 are changed to the Wi-Fi mode. The user preference for sharing the device state between the plurality of devices may be shown in Table 3.

TABLE 3

| | |
|---|---|
| User | <User-Pref id=abc123> |
| preference | <mode-sync state=“on”>> |
| | <wifi-sync> true </wifi-sync> |
| | <airplane-sync> true </airplane-sync> |
| | <sleep-sync> true </sleep-sync> |
| | <manner-sync> true </manner-sync> |
| | <roaming-sync> true </roaming-sync> |
| | </mode-sync> |
| | </User-Pref> |

As shown in Table 3, an element (e.g., <mode-sync>) for device mode synchronization in the user preference may include <wifi-sync> (e.g., a preference about whether to synchronize a Wi-Fi mode between devices (e.g., between the electronic device 100 and the first and second electronic devices 301 and 302), <airplane-sync> (e.g., a preference about whether to synchronize an airplane mode between the devices), <sleep-sync> (e.g., a preference about whether to synchronize a sleep mode between the devices), <manner-sync> (e.g., a preference about whether to synchronize a manner mode between the devices), <roaming-sync> (e.g., a preference about whether to synchronize a roaming mode between the devices), and the like.

According to various embodiments, if synchronization for a network setting between the electronic device 100 and the first and second external electronic devices 301 and 302 is set and if Wi-Fi mode synchronization (<wifi sync>) between the devices (e.g., the electronic device 100 and the first and second external electronic devices 301 and 302) is set to true, the server 200 may verify a DSP of a first external electronic group (e.g., the first external electronic device 301 or external electronic devices classified into a first group) and may change a network setting of each of external electronic devices in the first external electronic device group to a Wi-Fi mode.

As described above, the function synchronization system according to an embodiment of the present disclosure may save data usage and may address the inconvenience of operating a separate device based on a batch function change of the external electronic devices which belong to the first external electronic device group. For example, since a user experience (UX) (e.g., a display) for settings is small in a wearable device (e.g., a smart watch or a synchronized external electronic device), there may be the inconvenience of operating the UX. However, depending on the application of an embodiment of the present disclosure, a user may simply change a Wi-Fi mode (or an LTE mode) of an external electronic device (or the wearable device) based on an operation of a master device (e.g., the electronic device 100) without separately operating a UX.

According to various embodiments, if the electronic device 100 is changed to an airplane environment function (or an airplane mode), it may change the corresponding changed information to a DSP by reflecting a profile or presence information of the user, stored in the server 200. Information about setting the airplane mode may be added as one of the profile or the presence information of the user. In the description of Tables 1 to 3, information indicating whether the electronic device 100 is in the airplane mode may include <deviceAirplane>.

According to various embodiments, the server 200 may determine that a device mode setting is changed to the airplane mode from the profile or the presence information of the user and may verify a user preference of whether to perform synchronization for an airplane mode setting between the electronic device 100 and the first and second external electronic device 301 and 302. If the synchronization for the airplane mode setting is set and if airplane mode synchronization (<airplane-sync>) between devices is set, the server 200 may verify a DSP of the second external electronic device 302 (or at least one specified external electronic device, for example, the first external electronic device 301) and may change a device mode setting (or a device function setting) of each of the first and second external electronic devices 301 and 302 to the airplane mode. Thus, the function synchronization system according to an embodiment of the present disclosure may change the at least one external electronic devices 301 and 302 to the airplane mode in an integrated manner to reduce battery consumption and may change the at least one external electronic devices 301 and 302 to the airplane mode simply and at one time. According to various embodiments, after external electronic devices are changed to the airplane mode, changed details of functions of the external electronic devices may be used for function synchronization for a changed function based on a communication mode (e.g., a Wi-Fi mode if an LTE mode is turned off based on a change of the airplane mode) enabled by the external electronic devices.

According to various embodiments, the server 200 may determine that a device mode setting is changed to a sleep mode from the profile or the presence information of the user and may verify a user preference about whether to perform synchronization for a sleep mode setting between the electronic device 100 and the first and second external electronic device 301 and 302. If the synchronization for the sleep mode setting is set and if sleep mode synchronization (<Sleep-sync>) between devices is set, the server 200 may verify a DSP of the second external electronic device 302 (or at least one specified external electronic device, for example, the first external electronic device 301) and may change a terminal mode setting (or a device function setting) of each of the first and second external electronic devices 301 and 302 to the sleep mode (e.g., a sleep wind mode in an air conditioner, a sleep light mode in a light, or a sleep music mode in an audio). Thus, the function synchronization system according to an embodiment of the present disclosure may change the at least one external electronic devices 301 and 302 to the sleep mode to reduce battery consumption and may change the at least one external electronic devices 301 and 302 to the sleep mode simply and at one time.

According to various embodiments, if a mode setting of the electronic device 100 is changed to a manner mode, the electronic device 100 may reflect the changed details in the profile and the presence information of the user, stored in the server 200 to change a DSP based on the changed details. Information about a manner mode setting may be added as one of the profile or the presence information of the user. Information indicating whether the electronic device 100 is in the sleep mode may be <deviceManner>. The server 200 may determine that a terminal mode setting is changed to a manner mode from the profile or the presence information of the user and may verify a user preference about whether to synchronize a manner mode setting between the electronic device 100 and the first and second external electronic device 301 and 302. The server 200 may verify a DSP of each of the first and second external electronic devices 301 and 302 and may change a device mode setting of each of the first and second external electronic devices 301 and 302 to the manner mode.

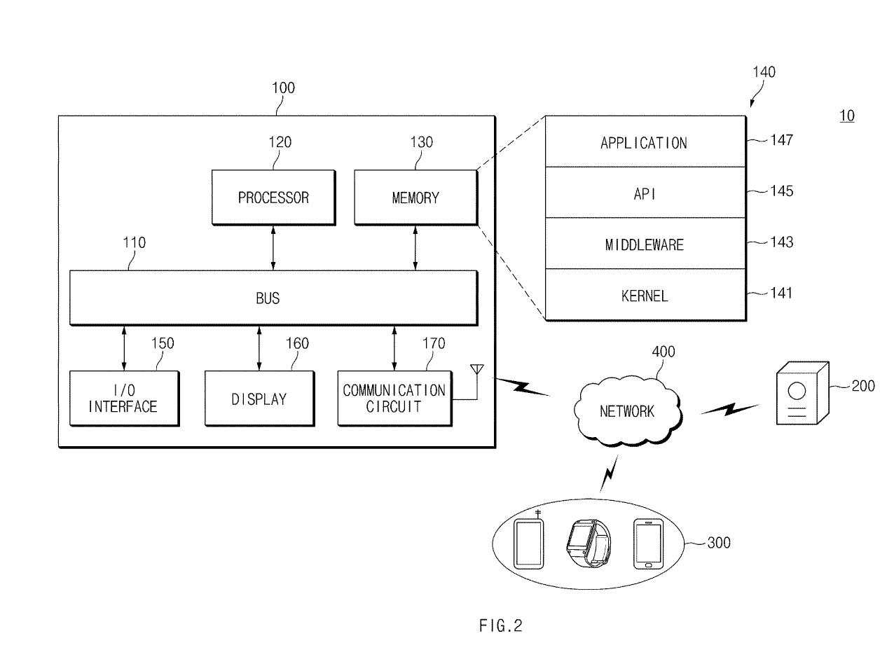

FIG. 2 is a block diagram illustrating an example of a function synchronization system according to an embodiment of the present disclosure.

Referring to FIG. 2, a function synchronization system 10 according to an embodiment may include an electronic device 100, a server 200, at least one external electronic device 300, and a network 400.

In the function synchronization system 10, the electronic device 100 may transmit synchronization configuration information or change information associated with function synchronization. Receiving the synchronization configuration information or the change information, the external electronic device 300 may determine to apply function synchronization in response to a user input or a specified policy. In this operation, a function of guiding a state where function synchronization of the external electronic device 300 is applied to the electronic device 100 may be selectively performed based on settings.

According to various embodiments, the function synchronization in the function synchronization system 10 may be applied to the external electronic device 300, a separation distance from the electronic device 100 of which is within a distance. In this regard, receiving update information from the server 200, the external electronic device 300 may obtain location information of the electronic device 100, its location information, or distance information between the electronic device 100 and the external electronic device 300 and may determine to apply update information (e.g., determine function synchronization) based on the obtained information. In this operation, the external electronic device 300 may verify whether there is the electronic device 100 within a transmission distance using a short-range communication module. Alternatively, the external electronic device 300 may obtain its location information using its specific sensor or its communication module, may compare the obtained location information with location information provided from the electronic device 100, and may determine to apply update information. According to various embodiments, in a process where the electronic device 100 transmits change information to the server 200, the electronic device 100 may search the external electronic device 300 around the electronic device 100 and may transmit information about the found external electronic device 300 to the server 200.

The network 400 may support to establish a communication channel between the electronic device 100 and the server 200 and establish a communication channel between the at least one external electronic device 300 and the server 200. In this regard, the network 400 may include at least one network device element to support a communication mode of a communication module (e.g., a hardware module) included in the electronic device 100 or the at least one external electronic device 300. For example, the network 400 may include a mobile communication network, the Internet, or the like.

The server 200 may provide a specified server page to the electronic device 100 or the at least one external electronic device 300, accessed via the network 400. For example, the server 200 may support to register a device of the electronic device 100 in connection with the function synchronization of the electronic device 100. Alternatively, the server 200 may receive a subscription request message of the at least one external electronic device 300 to be synchronized with the electronic device 100. Alternatively, when a specified function of the electronic device 100 is changed, the server 200 may receive change information according to the change in the function from the electronic device 100. Alternatively, the server 200 may update information based on the reception of the change information to generate the update information and may transmit update information to the at least one specified external electronic device 300. The above-mentioned server 200 may be, for example, a server which supports an IMS. Alternatively, the server 200 may include at least one of a presence server or a user profile processing server among IMS servers.

The at least one external electronic device 300 may be, for example, an electronic device which may access the server 200 via the network 400. Alternatively, according to various embodiments, the at least one external electronic device 300 may be an electronic device which may receive update information from the server 200. According to an embodiment, the external electronic device 300 may be a wearable electronic device. Alternatively, the external electronic device 300 may be a tablet electronic device. Alternatively, the external electronic device 300 may be another electronic device which supports substantially the same function as the electronic device 100. The external electronic device 300 may access the server 200 in response to a user input and may request a subscription message associated with function synchronization. If receiving update information from the server 200, the external electronic device 300 may process function synchronization in response to the received update information. According to various embodiments, the external electronic device 300 may request user verification in connection with processing update information. The external electronic device 300 may process the function synchronization or may maintain a function which is being previously performed, based on the user input.

According to various embodiments, the external electronic device 300 may include a short-range communication module which may establish a short-range communication channel. If receiving the update information, the external electronic device 300 may verify whether there is the electronic device 100 around the external electronic device 300 using the short-range communication module. If the electronic device 100 is within a distance at which it may establish a communication channel based on the short-range communication module, the external electronic device 300 may process function synchronization according to the update information. Alternatively, if the electronic device 100 is within a distance at which it may fail to establish a short-range communication channel, the external electronic device 300 may disregard the update information or may guide that there is not the electronic device 100 within a distance. Alternatively, the external electronic device 300 may transmit a message for guiding that function synchronization may fail to be performed to the electronic device 100 via the server 200 or may transmit the message to the electronic device 100 (e.g., based on a communication channel using a remote communication module), while maintaining a previous function.

The electronic device 100 may perform a master device function associated with the function synchronization. For example, the electronic device 100 may register a device setting associated with the function synchronization in the server 200. When a function of the electronic device 100 is changed, the electronic device 100 may transmit the change information to the server 200. The electronic device 100 may include a bus 110, a processor 120, a memory 130, an input/output (I/O) interface 150, a display 160, and a communication interface 170.

The bus 110 may include, for example, a circuit which connects the components 120 to 170 with each other and sends communication (e.g., a control message and/or data) between the components 120 to 170.

The processor 120 may include one or more of a central processing unit (CPU), an application processor (AP), or a communication processor (CP). The processor 120 may perform, for example, calculation or data processing about control and/or communication of at least another of the components of the electronic device 100. According to various embodiments, the processor 120 may operate a function associated with function synchronization. For example, the processor 120 may access the server 200, may register a device setting associated with the function synchronization, and may transmit change information about a change in a function of the electronic device 100.

The memory 130 may include a volatile and/or non-volatile memory. The memory 130 may store, for example, a command or data associated with at least another of the components of the electronic device 100. According to an embodiment, the memory 130 may store software and/or a program 140. The program 140 may include, for example, a kernel 141, a middleware 143, an application programming interface (API) 145, and/or at least one application program 147 (or “at least one application”), and the like. At least part of the kernel 141, the middleware 143, or the API 145 may be referred to as an operating system (OS).

The kernel 141 may control or manage, for example, system resources (e.g., the bus 110, the processor 120, or the memory 130, and the like) used to execute an operation or function implemented in the other programs (e.g., the middleware 143, the API 145, or the application program 147). Also, as the middleware 143, the API 145, or the application program 147 accesses a separate component of the electronic device 100, the kernel 141 may provide an interface which may control or manage system resources.

The middleware 143 may play a role as, for example, a go-between such that the API 145 or the application program 147 communicates with the kernel 141 to communicate data with the kernel 141. Also, the middleware 143 may process one or more work requests, received from the at least one application program 147, in order of priority. For example, the middleware 143 may assign priority which may use system resources (the bus 110, the processor 120, or the memory 130, and the like) of the electronic device 100 to at least one of the at least one application program 147. For example, the middleware 143 may perform scheduling or load balancing for the one or more work requests by processing the one or more work requests in order of priority assigned to the at least one of the at least one application program 147.

The API 145 may be, for example, an interface in which the application program 147 controls a function provided from the kernel 141 or the middleware 143. For example, the API 145 may include at least one interface or function (e.g., a command) for file control, window control, image processing, or text control, and the like. The application 147 may include, for example, an application associated with operating function synchronization.

According to an embodiment, the application 147 may include an application (hereinafter, for convenience of description, referred to as “information exchange application”) for exchanging information between an electronic device (e.g., the electronic device 100) and an external electronic device (e.g., the external electronic device 300). The information exchange application may include, for example, a notification relay application for transmitting specific information to the external electronic device or a device management application for managing the external electronic device.

For example, the notification relay application may include a function of transmitting notification information, which is generated by other applications (e.g., a short message service/multimedia message service (SMS/MMS) application, an electronic mail (email) application, a health care application, or an environment information application, and the like) of the electronic device, to the external electronic device. Also, the notification relay application may receive, for example, notification information from the external electronic device, and may provide the received notification information to a user of the electronic device.

The device management application may manage (e.g., install, delete, or update), for example, at least one (e.g., a function of turning on/off the external electronic device itself (or partial components) or a function of adjusting brightness (or resolution) of the display 160) of functions of the external electronic device which communicates with the electronic device, an application which operates in the external electronic device, or a service (e.g., a call service or a message service) provided from the external electronic device.

According to an embodiment, the application 147 may include a specified application (e.g., a health care application of a mobile medical device) based on attributes of the external electronic device. According to an embodiment, the application 147 may include an application received from the external electronic. According to an embodiment, the application 147 may include a preloaded application or a third party application which may be downloaded from a server (e.g., the server 200). Names of the components of the program module according to the shown embodiment may differ according to kinds of OSs.

The I/O interface 150 may play a role as, for example, an interface which may send a command or data, input from the user or another external device, to another component (or other components) of the electronic device 100. Also, the I/O interface 150 may output a command or data, received from another component (or other components) of the electronic device 100, to the user or the other external device. According to an embodiment, the I/O interface 150 may receive a user input associated with operating function synchronization.

The display 160 may include, for example, a liquid crystal display (LCD), a light emitting diode (LED) display, an organic LED (OLED) display, a microelectromechanical systems (MEMS) display, or an electronic paper display. The display 160 may display, for example, a variety of content (e.g., text, an image, a video, an icon, or a symbol, and the like) to the user. The display 160 may include a touch screen, and may receive, for example, a touch, a gesture, proximity, or a hovering input using an electronic pen or part of a body of the user. The display 160 may output at least one screen associated with function synchronization. For example, the display 160 may output a server access screen, a device setting screen, a function change screen, and the like provided from the server 200.

The communication interface 170 may establish communication between, for example, the electronic device 100 and an external device or the at least one external electronic device 300. For example, the communication interface 170 may connect to the network 400 through wireless communication or wired communication and may communicate with the server 200. The communication interface 170 may be in charge of transmitting and receiving a signal associated with registering a payment means.

The wireless communication may use, for example, at least one of long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), and the like as a cellular communication protocol. Also, the wireless communication may include, for example, local-area communication. The local-area communication may include, for example, at least one of wireless-fidelity (Wi-Fi) communication, Bluetooth (BT) communication, near field communication (NFC) communication, magnetic stripe transmission (MST) communication, or global navigation satellite system (GNSS) communication. The local-area communication may include local-area communication with the at least one external electronic device 300. The electronic device 100 may verify whether there is the external electronic device 300 within a specified distance, based on the local-area communication.

An MST module (or an MST circuit) may generate a pulse based on transmission data using an electromagnetic signal and may generate a magnetic field signal based on the pulse. The electronic device 100 may send the magnetic field signal to a point of sales (POS) system. The POS system may restore the data by detecting the magnetic field signal using an MST reader and converting the detected magnetic field signal into an electric signal.

The GNSS may include, for example, at least one of a global positioning system (GPS), a global navigation satellite system (Glonass), a Beidou navigation satellite system (hereinafter referred to as “Beidou”), or a Galileo (i.e., the European global satellite-based navigation system) according to an available area or a bandwidth, and the like. Hereinafter, the “GPS” used herein may be interchangeably with the “GNSS”. The wired communication may include at least one of, for example, universal serial bus (USB) communication, high definition multimedia interface (HDMI) communication, recommended standard 232 (RS-232) communication, or plain old telephone service (POTS) communication, and the like. The network 400 may include a telecommunications network, for example, at least one of a computer network (e.g., a local area network (LAN) or a wide area network (WAN)), the Internet, or a telephone network.

According to an embodiment, if the electronic device 100 will perform any function or service automatically or by a request, it may request another device (e.g., the external electronic device 300 or the server 200) to perform at least part of the function or service, rather than executing the function or service for itself or in addition to the function or service. The other electronic device (e.g., the external electronic device 300 or the server 200) may execute the requested function or the added function and may transmit the executed result to the electronic device 100. The electronic device 100 may process the received result without change or additionally and may provide the requested function or service. For this purpose, for example, cloud computing technologies, distributed computing technologies, or client-server computing technologies may be used.

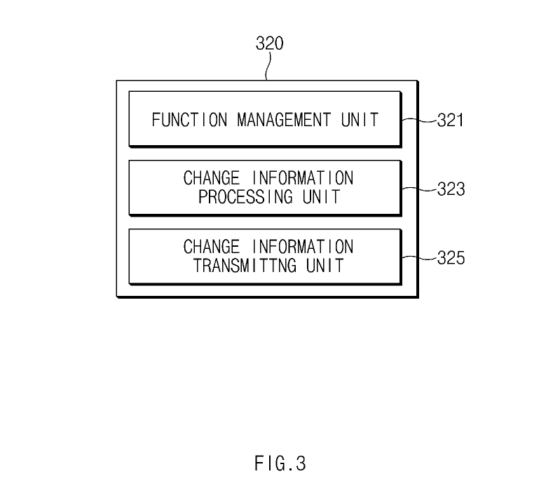

FIG. 3 is a block diagram illustrating an example of function modules based on a processor or a memory according to an embodiment of the present disclosure.

Referring to FIG. 3, a processor 320 may include a function management unit 321, a change information processing unit 123323 and a change information transmitting unit 325. Function modules shown in FIG. 3 may be implemented as hardware modules based on the processor 320. For example, at least one of the function management unit 321, the change information processing unit 323, or the change information transmitting unit 325 may be implemented utilizing at least part of the processor 320, or each of function management unit 321, the change information processing unit 323, or the change information transmitting unit 325 may be implemented utilizing at least one processor. Alternatively, the function modules may be implemented as software modules (e.g., based on a memory 130 of FIG. 2) and may be loaded into the memory 130 to be executed by the processor 320. Hereinafter, an embodiment is described in which the function management unit 321, the change information processing unit 323, or the change information transmitting unit 325 are hardware modules included in the processor 320. However, the described embodiments are not limited thereto. For example, as described above, the function modules may be software loaded into the memory 130 and executed by the processor 320.

The function management unit 321 may manage a function of the electronic device 100 and may control the electronic device 100 based on the corresponding function. For example, the function management unit 121 may execute an LTE function (or an LTE mode), a Wi-Fi function (or a Wi-Fi mode), a manner function, a sleep function, an airplane function, and the like. The function management unit 121 may monitor whether the above-mentioned function are enabled. If the corresponding function is executed or disabled, the function management unit 121 may obtain information about the corresponding function and may transmit the obtained information to the change information processing unit 323. According to an embodiment, the function management unit 321 may obtain function state values (e.g., a value indicating an execution state, a value indicating an inactive state, or the like) based on a request of the change information processing unit 323 in connection with function synchronization. The function management unit 321 may transmit the obtained function state values to the change information processing unit 323. Alternatively, if a specific function state is changed in response to a user input or the arrival of a specified schedule, the function management unit 321 may transmit the changed function state values to the change information processing unit 323.

The change information processing unit 323 may write a message associated with function synchronization. For example, when the electronic device 100 accesses a server 200 of FIG. 2 which supports the function synchronization, the change information processing unit 323 may control to output or display of a server page, associated with the function synchronization, provided from the server 200. The change information processing unit 323 may request the server 200 to transmit a synchronization configuration information form (e.g., a DSP message) associated with the function synchronization. If the synchronization configuration information form is received, the change information processing unit 323 may request the function management unit 321 to provide function state values. The change information processing unit 323 may write synchronization configuration information based on the function state values. The change information processing unit 323 may transmit the written synchronization configuration information to the server 200.

According to various embodiments, the change information processing unit 323 may provide a user interface for selecting at least one external electronic device 300 of FIG. 2, in connection with the function synchronization. For example, the change information processing unit 323 may output an input window for receiving inputs indicating connection information (e.g., information for transmitting update information to an external electronic device). Alternatively, the change information processing unit 323 may output a list of external electronic devices, registered with an account associated with an electronic device 100 of FIG. 2. The change information processing unit 323 may transmit identification information of the external electronic device 300, selected in response to a user input, to the specified server 200, included in the synchronization configuration information.

According to various embodiments, the change information processing unit 323 may receive changed details of function state values from the function management unit 321. If receiving a function state value changed in response to a state change in a function, the change information processing unit 323 may generate change information based on the received state value in the function. The change information processing unit 323 may transmit the generated change information to the change information transmitting unit 325.

The change information transmitting unit 325 may transmit synchronization configuration information to the specified server 200 in response to a request of the change information processing unit 323. Alternatively, the change information transmitting unit 325 may transmit change information to the specified server 200 in response to a request of the change information processing unit 323. In this regard, the change information transmitting unit 325 may store and manage address information of the specified server 200. A message transmitted to the specified server 200 by the change information transmitting unit 325 may include, for example, a DSP or user profile information.

According to an embodiment, the electronic device may include a memory configured to store synchronization configuration information associated with function synchronization with an external electronic device and a processor configured to operatively connect to the memory, wherein the processor is configured to transmit synchronization configuration information written based on a state of each of set functions to a server and when at least one function associated with the function synchronization is changed, transmit change information according to the change in the function to the server.

According to various embodiments, the processor may be configured to when an event associated with a change in a network setting of the electronic device is generated, transmit change information including a function state value corresponding to the changed network setting to the server.

According to various embodiments, the processor may be configured to if the network setting is changed in response to a change in a location of the electronic device, transmit change information including a function state value corresponding to the network setting to the server.

According to various embodiments, the processor may be configured to when an event associated with a change in a sleep setting of the electronic device is generated, transmit control information for controlling an external electronic device to have an operation state to the server.

According to various embodiments, the processor may be configured to output a list of at least one external electronic device to which the function synchronization will be applied.

According to various embodiments, the processor may be configured to output a list of external electronic devices to which the function synchronization will be applied, the list written based on an external electronic device located within a distance from the electronic device.

According to various embodiments, the processor may be configured to output a user interface associated with adding or deleting an external electronic device to which the function synchronization will be applied.

According to various embodiments, the processor may be configured to output a function item list comparing a function for selecting or cancelling at least one function to which the function synchronization will be applied.

According to various embodiments, the processor may be configured to when an input signal for requesting a change in a function of the electronic device is generated, output a user interface for verifying whether to synchronize a change state of the function with an external electronic device.

According to various embodiments, the processor may be configured to transmit the change information associated with the function synchronization to the external electronic device based on a user input.

According to various embodiments, the processor may be configured to output a list of at least one external electronic device to perform function synchronization based on a user input.

According to various embodiments, the processor may be configured to output a list of at least one external electronic device to perform function synchronization based on a user input.

According to various embodiments, the processor may be configured to output a list of at least one external electronic device to perform function synchronization based on communication channel connection history.

According to various embodiments, the processor may be configured to output a list of at least one external electronic device to perform function synchronization based on an account.

According to various embodiments, the processor may be configured to output a list of at least one external electronic device to perform function synchronization based on external electronic devices located within a distance from an electronic device.

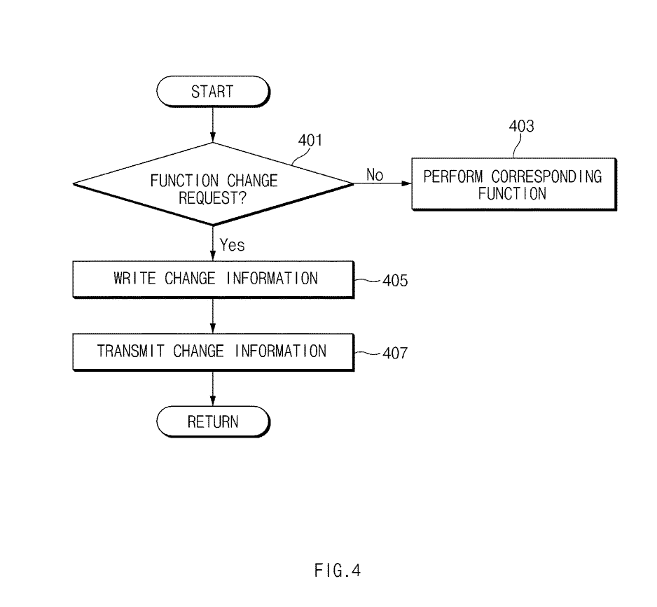

FIG. 4 is a flowchart illustrating a method for operating an electronic device associated with function synchronization according to an embodiment of the present disclosure.

Referring to FIG. 4, in connection with operating the electronic device, in operation 401 a processor 120 (e.g., a function management unit 121 of FIG. 3) may determine whether an input signal associated with a function change request occurs. In this regard, the processor 120 may provide an item or menu associated with the function change request. If an input signal corresponding to the corresponding item or menu is generated, the processor 120 may determine that an input signal associated with a function change occurs. According to various embodiments, if a specified function is changed by a change in a location of the electronic device 100 (e.g., a change in a location of the electronic device 100 by movement of a user who holds the electronic device 100) and the arrival of a scheduled time, or the like, the processor 120 may determine that an input signal associated with the change in the function occurs. If the generated input signal is not an input signal associated with a function change request, then in operation 403, the processor 120 (e.g., the function management unit 121) may perform a function according to the input signal. For example, the processor 120 may execute a file playback function, support a web search function, or support an image capture function, in response to a type of the input signal.

If the input signal associated with the function change request is generated, then in operation 405, the processor 120 (e.g., a change information processing unit 123 of FIG. 3) may generate change information according to a changed function. In this operation, the processor 120 (e.g., the function management unit 121) may change a function in response to selection of an item or menu associated with a function change or occurrence of a specific event. The processor 120 (e.g., the change information processing unit 123) may obtain a function setting value in response to a function change and may write change information based on the obtained function setting value.

In operation 407, the processor 120 (e.g., a change information transmitting unit 125) may transmit the generated change information to a specified server (e.g., 200 of FIG. 2). For example, the processor 120 may transmit the change information to the server 200 providing a synchronization setting information form. The change information may include, for example, identification information of an electronic device 100 of FIG. 2. Also, the change information may include identification information (or connection information) of at least one external electronic device to which the change information will be applied. If the server 200 stores and manages identification information or connection information of at least one external electronic device 300 of FIG. 2 to which the change information will be applied based on identification information of the electronic device 100, the identification information of the external electronic device 300 may be excluded from the change information.

According to various embodiments, when generating the change information, the electronic device 100 may perform a search around the electronic device 100 using a short-range communication module. The electronic device 100 may transmit identification information of at least one external electronic device associated with function synchronization among the found external electronic devices to the specified server 200, included in the change information.

According to various embodiments, a user of the electronic device 100 may set user preferences and a DSP (e.g., a device group, a DSP rule, and a subscription to a DSP of each of slave devices (e.g., first and second external electronic devices 301 and 302 of FIG. 1) in advance as pre-conditions. In this case, if changing a device mode from an LTE mode to a Wi-Fi mode, a master device (e.g., the electronic device 100) of a “user A” may verify whether a device mode between devices is synchronized or updated. Device mode synchronization of devices (e.g., the at least one external electronic devices 301 and 302) of the user A may be performed for each device mode. If the user A sets (e.g., turns on) device mode synchronization between devices, the master device may notify a server of the changed details of a device mode, that is, the changed details of the terminal mode for changing from an LTE mode to a Wi-Fi mode.

According to an embodiment, a method may include transmitting synchronization configuration information generated based on a state of each of set functions to a server and obtaining a function state value according to a state change in a function of an electronic device, generating change information in response to the state change in the function and transmitting the written change information to the server.

According to various embodiments, the transmitting of the written change information may include, when an event associated with a change in a network setting of the electronic device is generated, transmitting change information including a function state value corresponding to the changed network setting to the server.

According to various embodiments, the transmitting of the written change information may include, if the network setting is changed in response to a change in a location of the electronic device, transmitting change information including a function state value corresponding to the network setting to the server.

According to various embodiments, the transmitting of the written change information may include, when an event associated with a change in a sleep setting of the electronic device is generated, transmitting control information for controlling an external electronic device to have an operation state to the server.

According to various embodiments, the method may further include outputting a list of at least one external electronic device to which function synchronization will be applied.

According to various embodiments, the method may further include outputting a list of external electronic devices to which the function synchronization will be applied, the list including an item for an external electronic device located within a distance from the electronic device.

According to various embodiments, the method may further include outputting a user interface associated with adding or deleting an external electronic device to which function synchronization will be applied.

According to various embodiments, the method may further include outputting a function item list including a function for selecting or cancelling at least one function to which function synchronization will be applied.

According to various embodiments, the method may further include, when an input signal for requesting a change in a function of the electronic device is generated, outputting a user interface for verifying whether to synchronize a change state of the function with an external electronic device.

According to various embodiments, the transmitting of the written change information may include transmitting the change information associated with function synchronization to the external electronic device based on a user input.

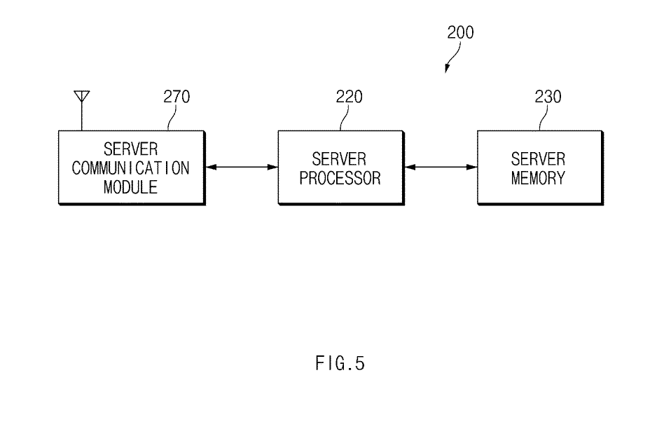

FIG. 5 is a block diagram illustrating an example of a server according to an embodiment of the present disclosure.

Referring to FIG. 5, a server 200 according to an embodiment may include a server processor 220, a server memory 230, and a server communication module 270.

The server communication module 270 (or a server communication circuit) may be in charge of a communication function of the server 200. For example, the server communication module 270 may establish a communication channel with an electronic device 100 of FIG. 2 based on a network 400 of FIG. 4. The server communication module 270 may transmit a synchronization configuration information form to the electronic device 100. The server communication module 270 may receive synchronization configuration information from the electronic device 100. The server communication module 270 may receive change information from the electronic device 100. The information received by the server communication module 270 may be transmitted to the server processor 220.

The server memory 230 may store at least one program or data utilized for operating the server 200. For example, the server memory 230 may store a synchronization configuration information form. According to an embodiment, the server memory 230 may store a program or data associated with function synchronization. For example, the server memory 230 may store synchronization configuration information of the at least one electronic device 100. Alternatively, the server memory 230 may store change information of the at least one electronic device 100. The server memory 230 may store update information generated by the server processor 220.

The server processor 220 may perform signaling and data transmission associated with operating the server 200. For example, the server processor 220 may provide a specified server page to the electronic device 100 in response to an access request of the electronic device 100. According to an embodiment, the server processor 220 may provide the synchronization configuration information form stored in the server memory 230 to the electronic device 100 in response to a request of the electronic device 100 or a specified policy. In this operation, if the electronic device 100 stores a synchronization configuration information form, the server processor 220 may verify version information and may provide a new synchronization configuration information form to the electronic device 100 based on a version.

If synchronization configuration information is received from the electronic device 100, the server processor 220 may store and manage the synchronization configuration information in the server memory 230. If information associated with the at least one specified external electronic device 300 is stored in the synchronization configuration information, the server processor 220 may separately store and manage the corresponding information. Alternatively, if a synchronization request message is received from the at least one external electronic device 300 in connection with function synchronization of the specific electronic device 100, the server processor 220 may store and manage connection information (or identification information) of the corresponding external electronic device 300 with synchronization configuration information associated with the corresponding electronic device 100. The synchronization request message may be a DSP subscription message. If a synchronization request message is received from the external electronic device 300, the server processor 220 may transmit synchronization configuration information as initial synchronization configuration information, provided from the electronic device 100, to the external electronic device 300.

The server processor 220 may receive change information in response to a change in a function of the electronic device 100. In this regard, the server processor 220 may monitor a change in a function of the electronic device 100 at a period or may receive change information corresponding to a change in the function from the electronic device 100. If receiving the change information, the server processor 220 may search the external electronic device 300 to perform function synchronization by the corresponding change information. The server processor 220 may generate update information to perform function synchronization at the external electronic device 300, based on the change information. The server processor 220 may transmit the update information to the corresponding external electronic device 300. In this operation, the server processor 220 may establish a communication channel with the external electronic device 300 based on a specified communication mode. If a communication interface which supports a specified communication mode of the external electronic device 300 is disabled, the server processor 220 may verify whether it is possible for the external electronic device 300 to operate another communication mode. If it is possible for the external electronic device 300 to operate the other communication mode, the server processor 220 may transmit update information to the external electronic device 300 based on a communication mode which may be operated by the external electronic device 300.

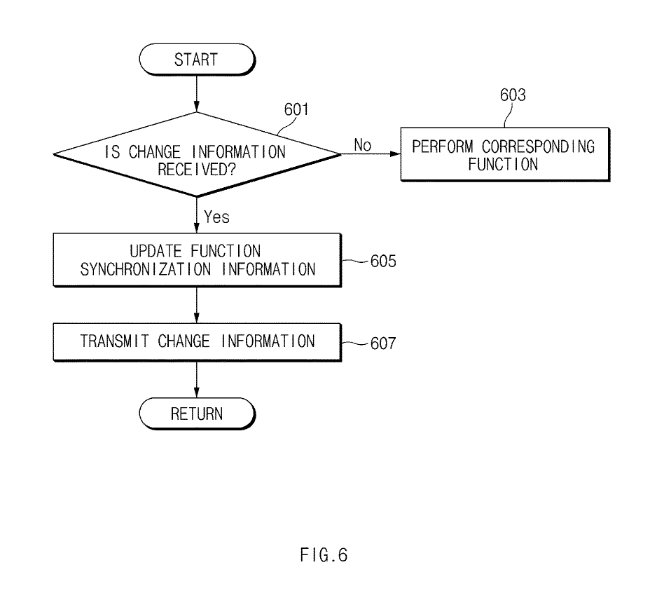

FIG. 6 is a flowchart illustrating a method for operating a server associated with function synchronization according to an embodiment of the present disclosure.

Referring to FIG. 6, in the server operation method according to an embodiment, in operation 601, a server processor 220 of FIG. 5 may determine whether change information is received from an electronic device 100 of FIG. 2. If the change information is not received, in operation 603, the server processor 220 may process a scheduled setting or task. For example, after the electronic device 100 accesses a server 200 of FIG. 5, if a DSP request occurs, the server processor 220 may transmit a specified DSP to the electronic device 100. The DSP may be a default file located for the electronic device 100 to use function synchronization.

If the change information is received, in operation 605, the server processor 220 may update function synchronization information. For example, the server processor 220 may verify identification information of the electronic device 100 which transmits the change information. The server processor 220 may verify synchronization configuration information corresponding to the corresponding electronic device 100, stored in a server memory 230 of FIG. 5. The server processor 220 may update synchronization configuration information using currently received change information. In the update process, the server processor 220 may generate update information to be transmitted to an external electronic device 300 of FIG. 2.

In operation 607, the server processor 220 may transmit the update information to the external electronic device 300. The server processor 220 may verify connection information of the external electronic device 300, stored in the server memory 230. The server processor 220 may transmit the update information to the external electronic device 300 based on the verified connection information. In this operation, the server processor 220 may verify a communication connection mode of the external electronic device 300 and may transmit the update information to the external electronic device 300 based on a currently connectable communication mode. Alternatively, the server processor 220 may attempt to connect a communication channel based on a specified communication connection mode. If failing in connecting the communication channel, the server processor 220 may transmit a message associated with failing in function synchronization to the electronic device 100.

The server 200 may include an operation rule associated with function synchronization like Table 4 below.

TABLE 4

| | |
|---|---|
| Generate DSP | Service Provider can create default profiles for |
| Document in | LTE, WiFi, Roaming, Airplane, Sleep etc. |
| XDM server | User can update these profiles and add more |
| | <conditions> and <actions>. |
| Generate DSP | DSP Directory document lists the profiles |
| Directory | available in DSP Document. |
| Document in | Application Server identifies the device |
| XDM server | connectivity, device mode for each device |
| | belonging to user and sets the active profile. |
| Monitor and | Application Server monitors connectivity status |
| Generate | and device mode of each user's devices and |
| Connectivity | updates the active profile in DSP Directory |
| and Device mode | Document. |
| User accesses | User can get notified about the list of profiles, |
| DSP Document and | name of active profile and if user can access the |
| DSP Directory | contents of profile too. |
| Document | |

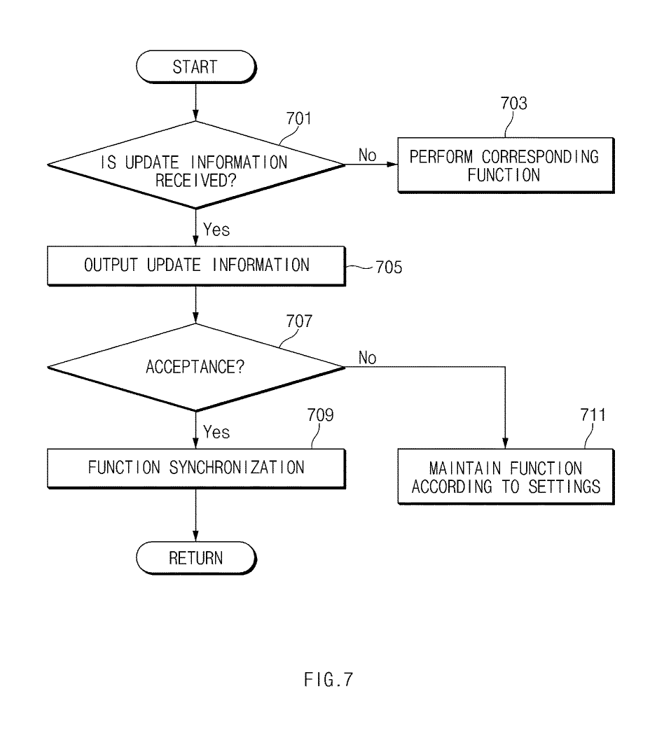

FIG. 7 is a flowchart illustrating a method for operating an external electronic device associated with function synchronization according to an embodiment of the present disclosure.

Referring to FIG. 7, in connection with the method for operating the external electronic device, in operation 701, an external electronic device 300 of FIG. 2 may determine whether update information is received. If the update information is not received, in operation 703, the external electronic device 300 may perform a specified function. For example, the external electronic device 300 may access a server 200 of FIG. 2 in response to a user input and may transmit a synchronization request message to the server 200. The external electronic device 300 may receive initial synchronization configuration information from the server 200 in response to transmitting the synchronization request message.

In the update information is received, in operation 705, the external electronic device 300 may output the update information. For example, the external electronic device 300 may output information regarding a function synchronization request of the electronic device 100 and may output a verification pop-up window and the like for verifying whether to apply corresponding function synchronization. In operation 707, the external electronic device 300 may verify whether there is a setting or a user input associated with accepting function synchronization which is requested by the update information.

If there is the setting or the user input associated with accepting the function synchronization, in operation 709, the external electronic device 300 may perform the function synchronization. When the update information is received, the external electronic device 300 may perform the function synchronization by a default setting (or without user verification). If a specific time elapses without the setting or the user input associated with accepting the function synchronization, if a user input for declining the function synchronization occurs, in operation 711, the external electronic device 300 may maintain a function according to settings.

According to various embodiments, an external electronic device may include a memory and a processor. The processor may be configured to perform function synchronization or maintain a previous function state based on a specified policy when receiving update information associated with the function synchronization.

According to various embodiments, the processor may be configured to output a pop-up window for guiding a state where the function synchronization is applied, when receiving the update information associated with the function synchronization.

According to various embodiments, the processor may be configured to output a pop-up window for determining whether to apply the corresponding function synchronization, when receiving the update information associated with the function synchronization.

According to various embodiments, the processor may be configured to verify whether a specified electronic device is located within a specified distance, when receiving the update information associated with the function synchronization, perform the function synchronization if the specified electronic device is within the specified distance, and not apply the function synchronization if the specified electronic device is not within the specified distance.

According to various embodiments, the processor may be configured to receive and output a list of electronic devices to perform the function synchronization based on accessing a server.

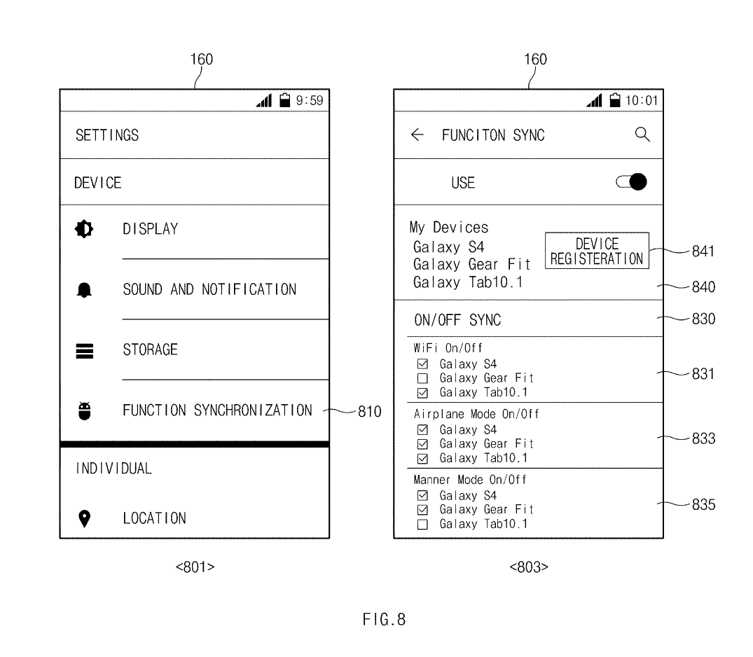

FIG. 8 is a drawing illustrating an example of a screen interface of an electronic device associated with setting function synchronization according to an embodiment of the present disclosure.

Referring to FIG. 8, in state 801, an electronic device 100 of FIG. 2 may output (e.g., display) a setting screen including a function synchronization item 810 associated with function synchronization on a display 160. For example, if an icon or a menu item associated with the function synchronization is selected, the electronic device 100 may output a setting screen as illustrated. Alternatively, if an input signal associated with outputting a setting screen is generated, the electronic device 100 may output the setting screen including the function synchronization item 810 as illustrated.

On the setting screen, if an input event selecting the function synchronization item 810 is generated, the electronic device 100 may output a function synchronization screen in state 803. The function synchronization screen may include function items 830 to apply function synchronization, as illustrated. The function items 830 may include, for example, a Wi-Fi function item 831, an airplane mode function item 833, a manner mode function item 835, and the like. The function items 830 may further include other items other than the function items shown in FIG. 8. For example, the function items 830 may include a Bluetooth function item, a function item for setting a specific mobile communication mode, an image capture function item, and the like.

In connection with the function items 830, the electronic device 100 may provide items relating to at least one external electronic device which is to perform function synchronization in connection with the function items 830, when selected. For example, as shown in FIG. 8, the electronic device 100 may provide a user interface for selecting at least one of a plurality of external electronic devices in the Wi-Fi function item 831. A user of the electronic device 100 may select at least one external electronic device to perform Wi-Fi function synchronization based on the corresponding user interface.

The function synchronization screen may include a guide region 840 including an item of external electronic devices which are requested to subscribe in connection with state and function synchronization, registered in a server 200 of FIG. 2 in connection with function synchronization. In FIG. 8, an embodiment is exemplified as a plurality of external electronic devices (e.g., a smartphone, a tablet personal computer or “PC”, a wearable device, and the like) are registered in the server 200 based on a state selected on the function items 830 in connection with function synchronization of the electronic device 100. If a device registration virtual key button 841 is selected, the electronic device 100 may generate synchronization configuration information to which the selected states, as set or indicated by selections to the function items 830, are then applied in connection with the function synchronization and transmitted as synchronization configuration information to the server 200. The guide region 840 may be provided by, for example, at least one of devices registered with an account of the electronic device 100, devices registered by a manual input of the user, or devices lists provided from the server 200.

As described above, the electronic device 100 may support activation and deactivation of a “setting and function synchronization” function in connection with the function synchronization. If the function synchronization is enabled, the electronic device 100 may support identification of a slave device (e.g., an external electronic device 300 of FIG. 2) registered in a master device (e.g., the electronic device 100) and additionally register a slave device. For example, the slave device registered in the master device may be added to a list to select whether synchronization is enabled based on a mode (or function). The electronic device 100 may support to check a slave device to synchronize a state change of each mode among external electronic devices added to the corresponding mode and select whether synchronization is enabled. For example, if an airplane mode of the master device is enabled, mode synchronization may be performed in Galaxy S4, Galaxy Gear Fit, Galaxy Tab 10.1 when an airplane mode of the master device is changed.

When device mode synchronization is applied to the slave device after function synchronization of the master device is enabled, a function synchronization system according to an embodiment of the present disclosure may perform function synchronization for all of slave devices registered by the user and may apply the function synchronization to slave devices located around the master device among slave devices registered by the user. Criteria of distinguishing slave devices located around the master device may be a distinguishing method and the like using a search through a Bluetooth connection, a cell identifier (ID) of a base station connected by data, a local area code, and the like.

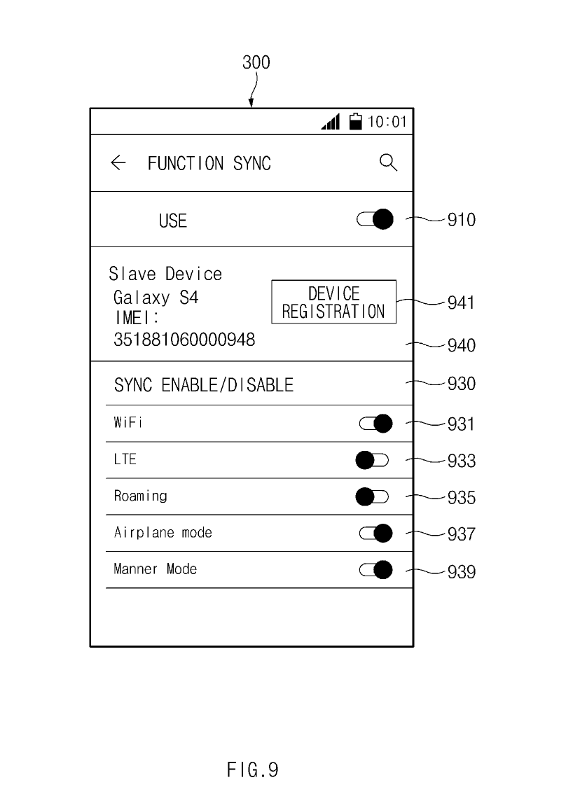

FIG. 9 is a drawing illustrating an example of a screen interface of an external electronic device associated with function synchronization according to an embodiment of the present disclosure.

Referring to FIG. 9, an external electronic device 300 of FIG. 2 may output or display a function synchronization setting screen as illustrated based on a user input or occurrence of a specified event. For example, the external electronic device 300 may provide an icon or a menu item associated with function synchronization. If the corresponding icon or menu icon is selected, as shown in FIG. 9, the external electronic device 300 may output a screen including a plurality of information associated with the function synchronization. The function synchronization setting screen of the external electronic device 300 may include, for example, a use item 910 for determining whether to apply function synchronization with an electronic device 100 of FIG. 2 based on received update information, an information region 940 where identification information of the external electronic device 300 and a virtual key button 941 associated with applying synchronization setting items are located, and synchronization setting items 930 for determining whether synchronization is enabled.

The synchronization setting items 930 may include, for example, a Wi-Fi setting item 931, an LTE setting item 933, a roaming setting item 935, an airplane function setting item 937, a manner mode setting item 939, and the like. A user of the external electronic device 300 may determine to set function synchronization of the external electronic device 300 associated with a corresponding setting item by swiping a setting button located on each of the synchronization setting items 930. If a function synchronization setting item is selected as “used”, the external electronic device 300 may apply function synchronization in response to update information received from a server 200 of FIG. 2. If the function synchronization setting item is selected as “unused”, the external electronic device 300 may disregard update information received from the server 200 and may maintain a previous function state. After the used or unused determination for the synchronization setting items 930 is completed, the virtual key button 941 may be selected. If the virtual key button 941 is selected, the external electronic device 300 may write a synchronization request message based on a used or unused state of each of the synchronization setting items 930 and may transmit the written synchronization request message to the server 200. The server 200 may write update information based on the synchronization request message. For example, the server 200 may write update information associated with an item in which function synchronization is selected as “used” and may transmit the written information to the corresponding external electronic device 300. According to various embodiments, the external electronic device 300 may store a setting for using each of the synchronization setting items 930 in its memory and may compare the stored setting with received update information, thus performing function synchronization.

As described above, a master device (e.g., the electronic device 100) may verify detailed information of a registered slave device (e.g., the external electronic device 300). According to various embodiments, the master device may support for the slave device to select whether to synchronize a corresponding value with respect to a function and mode to be synchronized by the master terminal. In FIG. 9, if Wi-Fi mode synchronization, airplane mode synchronization, manner mode synchronization are enabled in the master terminal and if LTE mode synchronization and roaming mode synchronization are disabled in the master terminal, Wi-Fi mode synchronization, airplane mode synchronization, and manner mode synchronization set in an external electronic device corresponding the master device, for example, Galaxy S4 may be enabled.

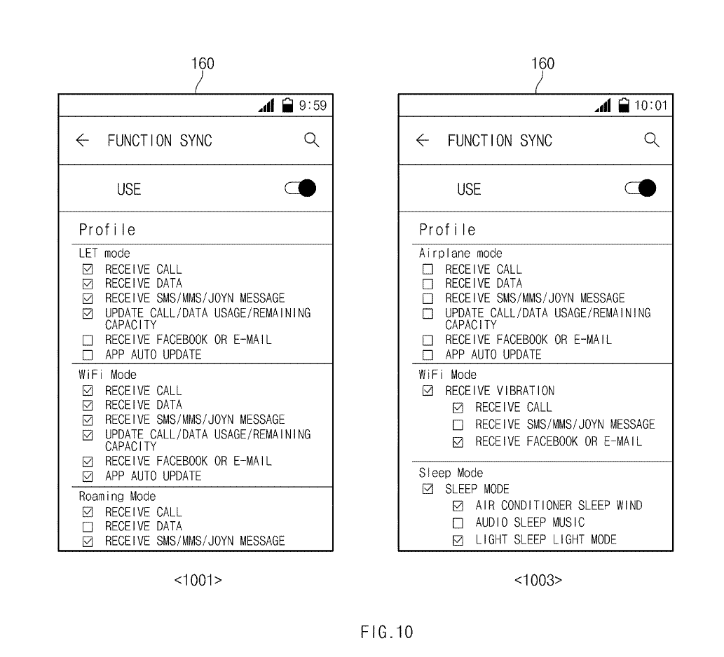

FIG. 10 is a drawing illustrating an example of a screen interface associated with selecting a detailed function of an electronic device associated with function synchronization according to an embodiment of the present disclosure.

Referring to FIG. 10, in connection with function synchronization, an electronic device 100 of FIG. 2 may output a user profile setting screen on a display 160. If an item associated with the function synchronization is selected, for example, in state 1001, in connection with a detailed setting of an LTE function and a detailed setting of a Wi-Fi function, the electronic device 100 may provide a call reception item, a data reception item, an SMS/MMS/Joyn message reception item, a call/data usage/remaining capacity update item, a Facebook/E-mail reception item, and an application (app) automatic update item. Also, in connection with a roaming function, the electronic device 100 may include a call reception item, a data reception item, and an SMS/MMS/Joyn message reception item. Detailed items associated with the roaming function may be further located in a lower portion. Detailed items associated with the roaming function, which are not displayed, may be displayed on the display 160 in response to a scroll input and the like.

In connection with the function synchronization, in state 1003, the electronic device 100 may output a detailed setting screen for other items on the display 160. For example, in connection with a detailed setting of an airplane function, the electronic device 100 may provide a call reception item, a data reception item, an SMS/MMS/Joyn message reception item, a call/data usage/remaining capacity update item, a Facebook/E-mail reception item, and an app automatic update item. Also, in connection with a detailed setting of a Wi-Fi function, the electronic device 100 may include a vibration reception item, a call reception item, an SMS/MMS/Joyn message reception item, and a Facebook/E-mail reception item. If the vibration reception item is not selected on the detailed setting of the Wi-Fi function, it is impossible to select the call reception item, the SMS/MMS/Joyn message reception item, or the Facebook/E-mail reception item. In connection with a detailed setting of a sleep function, the electronic device 100 may provide a sleep mode item. If the sleep mode item is selected, the electronic device 100 may provide an air conditioner sleep wind item, an audio sleep music item, a light sleep light mode item, and the like.

As described above, the electronic device 100 may have information enabled/disabled in each function (or mode). A user of the electronic device 100 may correct the enabled/disabled information. Anew mode may be added or deleted and an active/inactive option (e.g., data reception) for each mode may be added, deleted, or corrected, based on device implementation. The electronic device 100 may perform function synchronization about the profile. For example, the electronic device 100 may enable four upper selection items in an LTE mode. If the electronic device 100 has an SIP URI (e.g., “sip:ronald.underwood@example.com”) for user recognition as a pre-condition, a document for a DSP may be defined by a separate rule in a [RFC4745] ‘ruleset’ document, and action according to conditions may be defined. For example, a profile associated with a specific function may be in Tables 5 to 8 below.

TABLE 5
LTE profile

LTE Profile
<rule id =f3g44r1>
<conditions>
LTE connection
</conditions>
<actions>
Deliver Notifications from Subscribed Services Blocked if Roaming case)
Deliver Message Notifications
Block 3rd party service Notifications
Many such actions can be included
</actions>
</rule>

In case of a LTE profile, if ‘id’ attributes (id=“f3g44r1”) is defined and if a condition is an LTE connection, notification for a service (e.g., a voice mail box, call/data usage/remaining capacity update, and the like) to which a user subscribes may be transmitted to a device group. Message (e.g., SMS/MMS/Joyn message) notification may also be transmitted, and 3^{rd} party service (e.g., social networking service (SNS) and E-mail) notification may fail to be transmitted. In addition, other utilized operations (e.g., app (Tmap and Milk radio) automatic update) may be defined.

TABLE 6
WiFi profile

WiFi Profile
<rule id =yth7564>
<conditions>
WiFi connection
</conditions>
<actions>
Deliver Notifications from Subscribed Services
Deliver Message Notifications
Deliver 3rdpartyserviceNotifications
Many such actions can be included
</actions>
</rule>

In case of a Wi-Fi profile, if ‘id’ attributes (id=“ythk764”) is defined and if a condition is a Wi-Fi connection, notification for a service to which the user subscribes may be transmitted to a device group. Also, in case of the Wi-Fi profile, message notification may also be transmitted, and 3^{rd} party service (e.g., SNS and E-mail) notification may be transmitted. In addition, in case of the Wi-Fi profile, other utilized operations may be defined.

TABLE 7
Airplane mode profile

Airplane Mode Profile
<rule id =11t2t45>
<conditions>
Airplane
</conditions>
<actions>
Block Notifications from Subscribed Services
Block Message Notifications
Block 3rdpartyserviceNotifications
Deactivate the data connection
Many such actions can be included
</actions>
</rule>

In case of an airplane mode profile, if ‘id’ attributes (id=“11t2t45”) is defined and if a condition is an airplane mode, the airplane mode profile may be configured to block notification for a service to which the user subscribes. Also, the airplane mode profile may be configured to block message notification and block 3^{rd} party service (e.g., SNS and E-mail) notification. The airplane mode profile may be configured to disable a data connection. The airplane mode profile may be configured to define other utilized operations.

TABLE 8
Sleep mode profile

Sleep Mode Profile
<rule id =ugeg456>
<conditions>
Sleep
</conditions>
<actions>
Block Notifications from Subscribed Services
Deliver Message Notifications
Block 3rdpartyserviceNotifications
Activate the maximum power saving mode for mobile, tablet
Activate the sleep mode for air-conditioner and lights
Many such actions can be included
</actions>
</rule>

In case of a sleep mode profile, if ‘id’ attributes (id=“ugeg456”) is defined and if a condition is a sleep mode, the sleep mode profile may be configured to block notification for a service to which the user subscribes. The sleep mode profile may be configured to transmit message notification and block 3^{rd} party service (e.g., SNS and E-mail) notification. The sleep mode profile may be configured to enable a device and a tablet in a maximum power saving mode. The sleep mode profile may be configured to enable an air conditioner and a light in a sleep mode. The sleep mode profile may be configured to define other utilized operations.

In a roaming profile, although not illustrated in the form of a separate table, if ‘id’ attributes (id=“ythk767”) are defined and if a condition is a roaming connection, notification for a service to which the user subscribes may be blocked. Message notification may be transmitted, and 3^{rd} party service (e.g. SNS and E-mail) notification may be blocked. In addition, other utilized operations may be defined.

Table 9 below may correspond to an example of a DSP directory.

TABLE 9
Content of Device Settings Profile (DSP) Directory Document of a user:

Create profiles named LTE, WiFi, Roaming, Airplane and Sleep etc.
Application Server selects LTE profile as Active device DSP from his master device whose
id is sip:ronald.underwood@example.com;gr= qazyhnujmgh78a.
Application Server selects WiFi profile (ref-id=“abc9i) as Active slave device DSP (id=1qaz)
if master devices network connection becomes WiFi connection and does profile change to
WiFi.
Application Server selects LTE profile (ref-id=“xyz8dh) as Active slave device DSP
(id=1qaz) if master devices network connection becomes LTE connection and does profile
change to LTE.
Application Server selects Airplane profile (ref-id=“ghi6k) as Active slave device DSP
(id=3edc) and apply it to the dedicated device group (dp-id=aaa111) if master devices mode
becomes Airplane mode and does profile change to Airplane.
Application Server selects Sleep profile (ref-id=“jkl5l) as Active slave device DSP (id=5tgb)
and apply it to the dedicated device group (dp-id=bbb222) if master devices mode becomes
Sleep mode and does profile change to Sleep.
Application Server selects Roaming profile (ref-id=“def7j) as Active slave device DSP
(id=1qaz) if master devices network connection becomes Roaming connection and does
profile change to Roaming.

As shown in Table 9 above, the server 200 may change device profiles of corresponding group devices (e.g., first and second external electronic devices 301 and 302 of FIG. 1) to an LTE mode, a Wi-Fi mode, an airplane mode, a sleep mode, a roaming mode, and the like based on a master device profile. A DSP directory document structure indicated by Table 9 described above may be defined in a form as shown in Table 10 below.

Table 10 below may include a directory document structure for a set (<dsp-set>) of device settings profiles, a set (<dp-set>) of devices associated with a device profile, a set (<active-dsp>) of device settings profiles enabled in a device, device settings profiles (<master-dsp>) enabled in a master device, a set (<ruleset>) of device settings profiles rules according to a change in a device mode of a device, a set (<slave-device-dsp-set>) of device settings profiles enabled in a slave device, a set (<active-device-dsp-set>) of devices to which device settings profiles are separately applied among devices, and the like.

TABLE 10
DSP directory document structure

<?xml version=“1.0” encoding=“UTF-8”?>
<dsp-directory xmlns=“urn:xml:xdm:dsp-directory”>
<!set of Device Settings Profiles available created-->
<!set of Device Settings Profiles for each mode-->
<dsp-set>
<dsp dsp-id=“xyz8dh”>
<display-name> LTE </display-name>
</dsp>
<dsp dsp-id=“abc9i”>
<display-name> Wifi </display-name>
</dsp>
<dsp dsp-id=“def7j”>
<display-name> Roaming </display-name>
</dsp>
<dsp dsp-id=ghi6k>
<display-name> Airplane </display-name>
</dsp>
<dsp dsp-id=jkl5l>
<display-name> Sleep </display-name>
</dsp>
</dsp-set>
<!set of Devices for Device Profiles available created-->
<!set of Device list (wearable device list, home appliance list, and master device list)-->
<dp-set>
<dp dp-id=aaa111”>
<display-name> wearable devices </display-name>
<device-list>
<device device-type=wearable device-
id=“sip:ronald.underwood@example.com;gr=kdfdhjkurgh97d/>
<device device-type=wearable device-
id=“sip:ronald.underwood@example.com;gr=yhndhjkurgh98d/>
<device device-type=wearable device-
id=“sip:ronald.underwood@example.com;gr=ujmdhjkurgh99d/>
</device-list>
</dp>
<dp dp-id=bbb222”>
<display-name> home appliances </display-name>
<device-list>
<device device-type=homeappliance device-
id=“sip:ronald.underwood@example.com;gr=qazdhjkurgh12q/>
<device device-type=homeappliance device-
id=“sip:ronald.underwood@example.com;gr=yhnwsxkurgh34r/>
<device device-type=homeappliance device-
id=“sip:ronald.underwood@example.com;gr?rfvdhjkurgh45t/>
</device-list>
</dp>
<dp dp-id=ccc333”>
<display-name> master device </display-name>
<device-list>
<device device-type=mobile device-
id=“sip:ronald.underwood@example.com;gr=qazyhnujmgh78a/>
<device device-type=tablet device-
id=“sip:ronald.underwood@example.com;gr=yhnujmikngh56d/>
</device-list>
</dp>
<dp-set>
<!set of Active Device Settings Profiles available created-->
<!set of Device Settings Profiles enabled in device-->
<active-dsp>
<!Master Devices Device Settings Profiles available created-->
<!Device Settings Profiles enabled in master device -->
<master-dsp>
<master-device-id=“sip:ronald.underwood@example.com;gr=qazyhnujmgh78a”/>
<active-device-dsp dsp-reference ref-id=“xyz8dh”> <! LTE Profile -->
</master-dsp>
<!set of Devices active Device Settings Profiles rule available created-->
<!set of device settings profiles rule according to change in device mode of master terminal
(e.g., if master terminal is changed to roaming, profile of slave device is changed/operated
to/as roaming profile) -->
<ruleset>
<rule id=f3g66r1”>
<conditions>
master device Connection becomes WiFi connection
</conditions>
<actions>
Activate WiFi Profile(ref-id=“abc9i) on behalf of the existing Profile of slave devices dsp
(id=1qaz)
</actions>
</rule>
<rule id=g6j88h1”>
<conditions>
master device Connection becomes LTE connection
</conditions>
<actions>
Activate LTE Profile(ref-id=“xyz8dh) on behalf of the existing Profile of slave devices dsp
(id=1qaz)
</actions>
</rule>
<rule id=r4y88s3”>
<conditions>
master devices Connection becomes Roaming connection
</conditions>
<actions>
Activate Roaming Profile(ref-id=“def7j) on behalf of the existing Profile of slave devices
dsp (id=1qaz)
</actions>
</rule>
<rule id=g3g22g1”>
<conditions>
master device becomes Airplane Mode
</conditions>
<actions>
Activate Airplane Mode (ref-id=“ghi6k) on the dedicated slave device group (dp-id=aaa111)
</actions>
</rule>
<rule id=a3g22d1”>
<conditions>
master device becomes Sleep Mode
</conditions>
<actions>
Activate Sleep Mode (ref-id=“jkl5l) on the dedicated slave device group (dp-id=bbb222)
</actions> </rule>
</ruleset>
<!set of Slave Devices active Device Settings Profiles available created-->
<!set of Device Settings Profiles Rules enabled in slave device (e.g., if master terminal is in
airplane mode(ghi6k), wearable device (aaa111) also applies airplane mode)-->
<slave-device-dsp-set>
<slave-device-dsp id=1qaz>
<dsp-reference ref-id=“xyz8dh”/> <! LTE Profile -->
<device-id=“sip:ronald.underwood@example.com;gr=kdfdhjkurgh97d”/>
<device-id=“sip:ronald.underwood@example.com;gr=qazdhjkurgh12q”/>
<device-id=“sip:ronald.underwood@example.com;gr=yhnujmikngh56d”/>
</slave-device-dsp>
<slave-device-dsp id=3edc>
<dsp-reference ref-id=“ghi6k”/> <! Airplane Profile -->
<dp-reference dp-id=aaa111/>
</slave-device-dsp>
<slave-device-dsp id=5tgb>
<dsp-reference ref-id=“jkl5l”/> <! Sleep Profile -->
<dp-reference dp-id=bbb222/>
</slave-device-dsp>
</slave-device-dsp-set>
<!set of Active Device Settings Profiles available created-->
<!set of Devices to which Device Settings Profiles are separately applied among Devices-->
<active-device-dsp-set>
<active-device-dsp id=2wsx>
<dsp-reference ref-id=“abc9i”/> <! WiFi Profile -->
<device-id=“sip:ronald.underwood@example.com;gr=yhndhjkurgh98d”/>
<device-id=“sip:ronald.underwood@example.com;gr=yhnwsxkurgh34r”/>
</active-device-dsp>
<active-device-dsp id=4rfv>
<dsp-reference ref-id=“ghi6k”/> <! Airplane Profile -->
<device-id=“sip:ronald.underwood@example.com;gr=yhnujmikngh56d/>
</active-device-dsp>
<active-device-dsp id=9olk>
<dsp-reference ref-id=“jkl5l”/> <! Sleep Profile -->
<device-id=“sip:ronald.underwood@example.com;gr=rfvdhjkurgh45t/>
</active-device-dsp-set>
</active-dsp>
</dsp-directory>

The device context profile directory structure may be standardized and implemented in the form of being partially corrected for necessity and scalability. Also, when the user subscribes to a provider service for each device group, data may be shared between devices (e.g., there may be a tethering service between a master device (e.g. the electronic device 100) and a wearable device (e.g., the external electronic device 300). When the user subscribes to a function synchronization service described according to an embodiment of the present disclosure, the electronic device 100 may set a default rule associated with a connectivity change and a mode change and may support a user change. If this rule is stored in the server 200 (e.g., when the master device enables the tethering service by generating a tethering profile, a specific device group may access the master device by the tethering service and may use a data service), although there is a limited input method or no input method via a wearable/Internet of things (IoT) device, data may be shared between devices and for each device through batch application and the input method may be addressed through the device settings profiles.

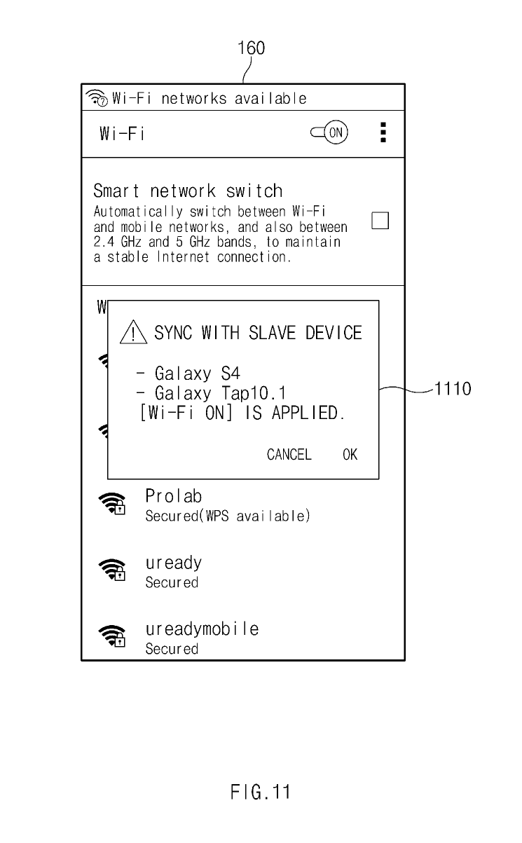

FIG. 11 is a drawing illustrating an example of a screen interface of an electronic device associated with applying function synchronization according to an embodiment of the present disclosure.

Referring to FIG. 11, if an event associated with setting a specific function (e.g., a Wi-Fi function) is generated, an electronic device 100 of FIG. 2 may verify whether the setting of the corresponding function is an item associated with function synchronization. If the setting of the corresponding function is the item associated with the function synchronization, as shown in FIG. 11, the electronic device 100 may output a pop-up window 1110 inquiring whether to apply synchronization. In this regard, the electronic device 100 may output an external electronic device registered with a specific account or at least one external electronic device adjacent within a distance on the pop-up window 1110 in connection with the function synchronization. If a cancel virtual key button for cancelling an application associated with the function synchronization is selected, the electronic device 100 may cancel function synchronization with an external electronic device 300 of FIG. 3.

The pop-up window 1110 may include, for example, a plurality of external electronic devices and selection items for indicating whether function synchronization is applied. If an input (e.g., an OK selection input) indicating that the function synchronization is applied occurs, the electronic device 100 may generate change information associated with the function synchronization and may transmit the generated change information to a server 200 of FIG. 2. In this operation, the electronic device 100 may transmit identification information or connection information of each of external electronic devices, included in the change information, to the server 200. Items associated with the external electronic devices included in the pop-up window 1110 may be selected in connection with the function synchronization. For example, as shown in FIG. 11, a Galaxy S4 item and a Galaxy Tab 10.1 item may be selected in connection with the function synchronization. If a user of the electronic device 100 wants to exclude the Galaxy S4 item in connection with the function synchronization, he or she may select the corresponding item and may exclude the selected item from the function synchronization. The above-mentioned pop-up window 1110 may be automatically removed, if a specified time elapses without a specified input. When a specified time elapses, the electronic device 100 may fail to perform the function synchronization or may automatically transmit change information associated with the function synchronization, based on a specified policy.

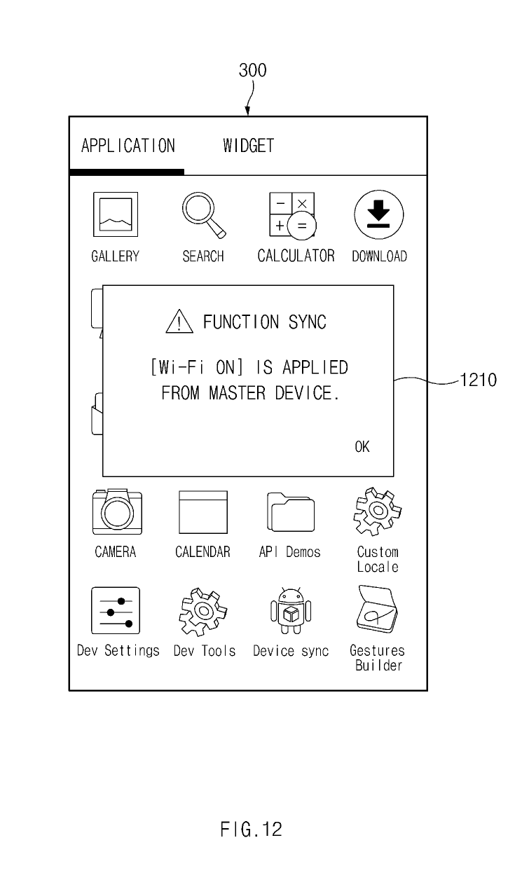

FIG. 12 is a drawing illustrating an example of a screen interface of an external electronic device associated with applying function synchronization according to an embodiment of the present disclosure.

Referring to FIG. 12, if receiving change information from a server 200 of FIG. 2 in connection with function synchronization, an external electronic device 300 of FIG. 2 may output a guide window 1210 associated with applying the function synchronization based on a specified setting or policy as illustrated. According to an embodiment, the external electronic device 300 may receive change information from the server 200 in a state where it outputs a specified function execution screen (e.g., an application search screen and the like). In this case, the external electronic device 300 may output the guide window 1210 associated with receiving and applying change information on a function execution screen currently applied.

According to various embodiments, the external electronic device 300 may maintain a previous function state without applying the function synchronization, based on a setting or a specified policy. For example, as the electronic device 100 is changed from an LTE function state to a Wi-Fi function state, the external electronic device 300 may receive a function synchronization request associated with changing to the Wi-Fi function state from the server 200 (or an electronic device 100 of FIG. 2). If the external electronic device 300 is configured to maintain the LTE function state, it may output a guide window. Although the external electronic device 300 receives a Wi-Fi function synchronization request of the electronic device 100 (e.g., a master device), it may output information for guiding that the LTE function state is currently maintained.

In the description above, an embodiment is exemplified as the system and method in which the external electronic device 300 receives the change information from the server 200. However, various embodiments of the present disclosure are not limited thereto. For example, the external electronic device 300 may directly receive change information from the electronic device 100. The external electronic device 300 may extract information associated with the external electronic device 300 from the received change information and may perform a function associated with function synchronization based on the extracted information.

As described above, various embodiments may more simply and quickly change a use change of each of a plurality of electronic devices based on function synchronization of each of the plurality of electronic devices.

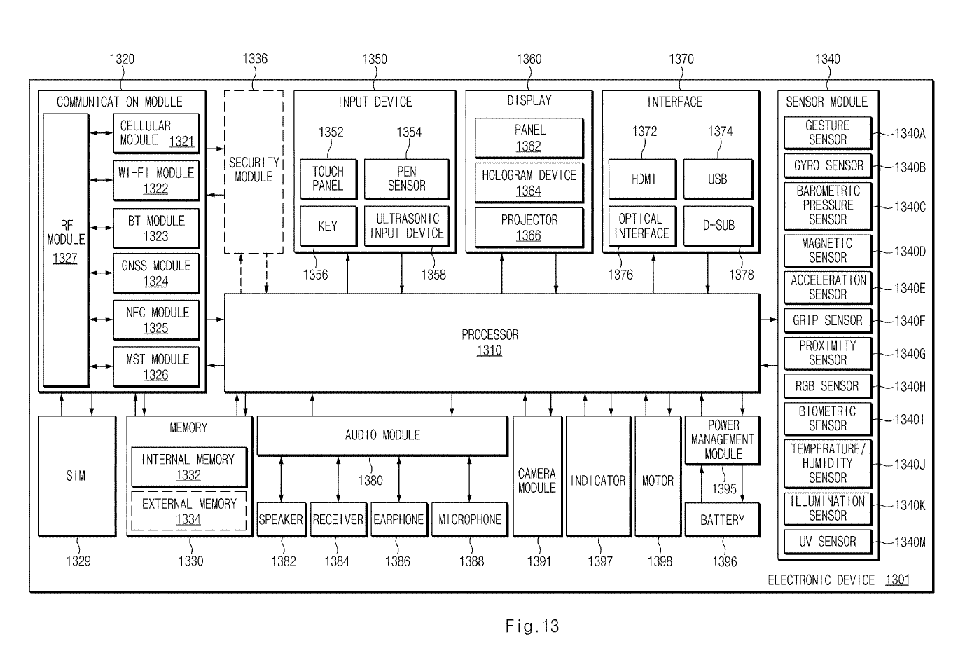

FIG. 13 is a block diagram illustrating a configuration of an electronic device according to various embodiments.

Referring to FIG. 13, the electronic device 1301 may include, for example, all or part of an electronic device 100 shown in FIG. 2. The electronic device 1301 may include one or more processors 1310 (e.g., application processors (APs)), a communication module 1320, a subscriber identification module (SIM) 1329, a memory 1330, a security module 1336, a sensor module 1340, an input device 1350, a display 1360, an interface 1370, an audio module 1380, a camera module 1391, a power management module 1395, a battery 1396, an indicator 1397, and a motor 1398.

The processor 1310 may drive, for example, an operating system (OS) or an application program to control a plurality of hardware or software components connected thereto and may process and compute a variety of data. The processor 1310 may be implemented with, for example, a system on chip (SoC). According to an embodiment, the processor 1310 may include a graphic processing unit (GPU) (not shown) and/or an image signal processor (not shown). The processor 1310 may include at least some (e.g., a cellular module 1321) of the components shown in FIG. 13. The processor 1310 may load a command or data received from at least one of other components (e.g., a non-volatile memory) into a volatile memory to process the data and may store various data in a non-volatile memory.

The communication module 1320 may have the same or similar configuration to a communication interface 1370 of FIG. 2. The communication module 1320 may include, for example, the cellular module 1321, a wireless-fidelity (Wi-Fi) module 1322, a Bluetooth (BT) module 1323, a global navigation satellite system (GNSS) module 1324 (e.g., a GPS module, a Glonass module, a Beidou module, or a Galileo module), a near field communication (NFC) module 1325, an MST module 1326, and a radio frequency (RF) module 1327.

The cellular module 1321 may provide, for example, a voice call service, a video call service, a text message service, or an Internet service, and the like through a communication network. According to an embodiment, the cellular module 1321 may identify and authenticate the electronic device 1301 in a communication network using the SIM 1329 (e.g., a SIM card). According to an embodiment, the cellular module 1321 may perform at least part of functions which may be provided by the processor 1310. According to an embodiment, the cellular module 1321 may include a communication processor (CP).

The Wi-Fi module 1322, the BT module 1323, the GNSS module 1324, the NFC module 1325, or the MST module 1326 may include, for example, a processor for processing data transmitted and received through the corresponding module. According to various embodiments, at least some (e.g., two or more) of the cellular module 1321, the Wi-Fi module 1322, the BT module 1323, the GNSS module 1324, the NFC module 1325, or the MST module 1326 may be included in one integrated chip (IC) or one IC package.

The RF module 1327 may transmit and receive, for example, a communication signal (e.g., an RF signal). Though not shown, the RF module 1327 may include, for example, a transceiver, a power amplifier module (PAM), a frequency filter, or a low noise amplifier (LNA), or an antenna, and the like. According to another embodiment, at least one of the cellular module 1321, the Wi-Fi module 1322, the BT module 1323, the GNSS module 1324, the NFC module 1325, or the MST module 1326 may transmit and receive an RF signal through a separate RF module.

The SIM 1329 may include, for example, a card which includes a SIM and/or an embedded SIM. The SIM 1329 may include unique identification information (e.g., an integrated circuit card identifier (ICCID)) or subscriber information (e.g., an international mobile subscriber identity (IMSI)).

The memory 1330 (e.g., a memory 130 of FIG. 2) may include, for example, an embedded memory 1332 or an external memory 1334. The embedded memory 1332 may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 1334 may include a flash drive, for example, a compact flash (CF), a secure digital (SD), a micro-SD, a mini-SD, an extreme digital (xD), a multimedia car (MMC), or a memory stick, and the like. The external memory 1334 may operatively and/or physically connect with the electronic device 1301 through various interfaces.

The secure module 1336 may be a module which has a relatively higher secure level than the memory 1330 and may be a circuit which stores secure data and guarantees a protected execution environment. The secure module 1336 may be implemented with a separate circuit and may include a separate processor. The secure module 1336 may include, for example, an embedded secure element (eSE) which is present in a removable smart chip or a removable SD card or is embedded in a fixed chip of the electronic device 1301. Also, the secure module 1336 may be driven by an OS different from the OS of the electronic device 1301. For example, the secure module 1336 may operate based on a java card open platform (JCOP) OS.

The sensor module 1340 may measure, for example, a physical quantity or may detect an operation state of the electronic device 1301, and may convert the measured or detected information to an electric signal. The sensor module 1340 may include at least one of, for example, a gesture sensor 1340A, a gyro sensor 1340B, a barometer sensor 1340C, a magnetic sensor 1340D, an acceleration sensor 1340E, a grip sensor 1340F, a proximity sensor 1340G, a color sensor 1340H (e.g., red, green, blue (RGB) sensor), a biometric sensor 1340I, a temperature/humidity sensor 1340J, an illumination sensor 1340K, or an ultraviolet (UV) sensor 1340M. Additionally or alternatively, the sensor module 1340 may further include, for example, an e-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), and/or a fingerprint sensor (not shown), and the like. The sensor module 1340 may further include a control circuit for controlling at least one or more sensors included therein. According to various embodiments, the electronic device 1301 may further include a processor configured to control the sensor module 1340, as part of the processor 1310 or to be independent of the processor 1310. While the processor 1310 is in a sleep state, the electronic device 1301 may control the sensor module 1340.

The input device 1350 may include, for example, a touch panel 1352, a (digital) pen sensor 1354, a key 1356, or an ultrasonic input device 1358. The touch panel 1352 may use at least one of, for example, a capacitive type, a resistive type, an infrared type, or an ultrasonic type. Also, the touch panel 1352 may further include a control circuit. The touch panel 1352 may further include a tactile layer and may provide a tactile reaction to a user.

The (digital) pen sensor 1354 may be, for example, part of the touch panel 1352 or may include a separate sheet for recognition. The key 1356 may include, for example, a physical button, an optical key, or a keypad. The ultrasonic input device 1358 may allow the electronic device 1301 to detect a sound wave using a microphone (e.g., a microphone 1388) and to verify data through an input tool generating an ultrasonic signal.

The display 1360 (e.g., a display 160 of FIG. 2) may include a panel 1362, a hologram device 1364, or a projector 1366. The panel 1362 may include the same or similar configuration to the display 160 or 160. The panel 1362 may be implemented to be, for example, flexible, transparent, or wearable. The panel 1362 and the touch panel 1352 may be integrated into one module. The hologram device 1364 may show a stereoscopic image in a space using interference of light. The projector 1366 may project light onto a screen to display an image. The screen may be positioned, for example, inside or outside the electronic device 1301. According to an embodiment, the display 1360 may further include a control circuit for controlling the panel 1362, the hologram device 1364, or the projector 1366.

The interface 1370 may include, for example, a high-definition multimedia interface (HDMI) 1372, a universal serial bus (USB) 1374, an optical interface 1376, or a D-subminiature 1378. The interface 1370 may be included in, for example, a communication interface 170 shown in FIG. 2. Additionally or alternatively, the interface 1370 may include, for example, a mobile high definition link (MHL) interface, an SD card/multimedia card (MMC) interface, or an infrared data association (IrDA) standard interface.

The audio module 1380 may convert a sound and an electric signal in dual directions. At least part of components of the audio module 1380 may be included in, for example, an input and output interface 150 (or a user interface) shown in FIG. 2. The audio module 1380 may process sound information input or output through, for example, a speaker 1382, a receiver 1384, an earphone 1386, or the microphone 1388, and the like.

The camera module 1391 may be a device which captures a still image and a moving image. According to an embodiment, the camera module 1391 may include one or more image sensors (not shown) (e.g., a front sensor or a rear sensor), a lens (not shown), an image signal processor (ISP) (not shown), or a flash (not shown) (e.g., an LED or a xenon lamp).

The power management module 1395 may manage, for example, power of the electronic device 1301. According to an embodiment, though not shown, the power management module 1395 may include a power management integrated circuit (PMIC), a charger IC or a battery or fuel gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 1396 and voltage, current, or temperature thereof while the battery 1396 is charged. The battery 1396 may include, for example, a rechargeable battery or a solar battery.

The indicator 1397 may display a specific state of the electronic device 1301 or part (e.g., the processor 1310) thereof, for example, a booting state, a message state, or a charging state, and the like. The motor 1398 may convert an electric signal into mechanical vibration and may generate vibration or a haptic effect, and the like. Though not shown, the electronic device 1301 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, or a mediaFlo™ standard, and the like.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

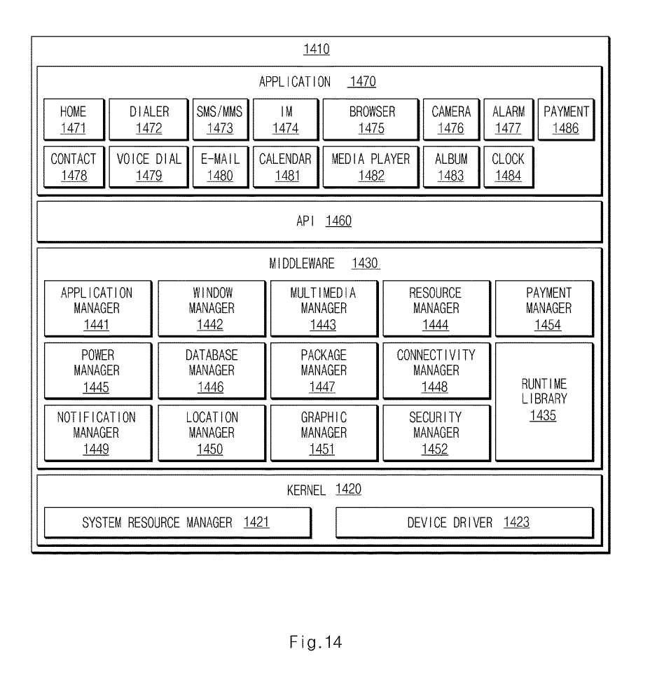

FIG. 14 is a block diagram illustrating a configuration of a program module according to various embodiments.

According to an embodiment, the program module 1410 (e.g., a program 140 of FIG. 2) may include an operating system (OS) for controlling resources associated with an electronic device (e.g., an electronic device 100 of FIG. 2) and/or various applications (e.g., an application program 147 of FIG. 2) which are executed on the OS. The OS may be, for example, Android™, iOS™, Windows™, Symbian™, Tizen™, or Bada™, and the like.

The program module 1410 may include a kernel 1420, a middleware 1430, an application programming interface (API) 1460, and/or an application 1470. At least part of the program module 1410 may be preloaded on the electronic device, or may be downloaded from an external electronic device (e.g., the server 200, an external electronic device 300 of FIG. 2).

The kernel 1420 (e.g., a kernel 141 of FIG. 2) may include, for example, a system resource manager 1421 and/or a device driver 1423. The system resource manager 1421 may control, assign, obtain, or collect, and the like system resources. According to an embodiment, the system resource manager 1421 may include a process management unit, a memory management unit, or a file system management unit, and the like. The device driver 1423 may include, for example, a display driver, a camera driver, a Bluetooth (BT) driver, a shared memory driver, a universal serial bus (USB) driver, a keypad driver, a wireless-fidelity (Wi-Fi) driver, an audio driver, or an inter-process communication (IPC) driver.

The middleware 1430 (e.g., a middleware 143 of FIG. 2) may provide, for example, functions the application 1470 needs in common, and may provide various functions to the application 1470 through the API 1460 such that the application 1470 efficiently uses limited system resources in the electronic device. According to an embodiment, the middleware 1430 (e.g., the middleware 143) may include at least one of a runtime library 1435, an application manager 1441, a window manager 1442, a multimedia manager 1443, a resource manager 1444, a power manager 1445, a database manager 1446, a package manager 1447, a connectivity manager 1448, a notification manager 1449, a location manager 1450, a graphic manager 1451, a security manager 1452, or a payment manager 1454.

The runtime library 1435 may include, for example, a library module used by a compiler to add a new function through a programming language while the application 1470 is executed. The runtime library 1435 may perform a function about input and output management, memory management, or an arithmetic function.

The application manager 1441 may manage, for example, a life cycle of at least one of the application 1470. The window manager 1442 may manage graphic user interface (GUI) resources used on a screen of the electronic device. The multimedia manager 1443 may determine a format utilized for reproducing various media files and may encode or decode a media file using a codec corresponding to the corresponding format. The resource manager 1444 may manage source codes of at least one of the application 1470, and may manage resources of a memory or a storage space, and the like.

The power manager 1445 may act together with, for example, a basic input/output system (BIOS) and the like, may manage a battery or a power source, and may provide power information utilized for an operation of the electronic device. The database manager 1446 may generate, search, or change a database to be used in at least one of the application 1470. The package manager 1447 may manage installation or update of an application distributed by a type of a package file.

The connectivity manager 1448 may manage, for example, wireless connection such as Wi-Fi connection or BT connection, and the like. The notification manager 1449 may display or notify events, such as an arrival message, an appointment, and proximity notification, by a method which is not disturbed to the user. The location manager 1450 may manage location information of the electronic device. The graphic manager 1451 may manage a graphic effect to be provided to the user or a user interface (UI) related to the graphic effect. The security manager 1452 may provide all security functions utilized for system security or user authentication, and the like. According to an embodiment, when the electronic device (e.g., an electronic device 100 of FIG. 2) has a phone function, the middleware 1430 may further include a telephony manager (not shown) for managing a voice or video communication function of the electronic device.

The middleware 1430 may include a middleware module which configures combinations of various functions of the above-described components. The middleware 1430 may provide a module which specializes according to kinds of OSs to provide a differentiated function. Also, the middleware 1430 may dynamically delete some of old components or may add new components.

The API 1460 (e.g., an API 145 of FIG. 2) may be, for example, a set of API programming functions, and may be provided with different components according to OSs. For example, in case of Android or iOS, one API set may be provided according to platforms. In case of Tizen, two or more API sets may be provided according to platforms.

The application 1470 (e.g., an application program 147 of FIG. 2) may include one or more of, for example, a home application 1471, a dialer application 1472, a short message service/multimedia message service (SMS/MMS) application 1473, an instant message (IM) application 1474, a browser application 1475, a camera application 1476, an alarm application 1477, a contact application 1478, a voice dial application 1479, an e-mail application 1480, a calendar application 1481, a media player application 1482, an album application 1483, a clock application 1484, a health care application (e.g., an application for measuring quantity of exercise or blood sugar, and the like), or an environment information application (e.g., an application for providing atmospheric pressure information, humidity information, or temperature information, and the like), a payment application 1486, and the like.

According to an embodiment, the application 1470 may include an application (hereinafter, for better understanding and ease of description, referred to as “information exchange application”) for exchanging information between the electronic device (e.g., the electronic device 100 of FIG. 2) and an external electronic device. The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device. Also, the notification relay application may receive, for example, notification information from the external electronic device, and may provide the received notification information to the user of the electronic device.

The device management application may manage (e.g., install, delete, or update), for example, at least one (e.g., a function of turning on/off the external electronic device itself (or partial components) or a function of adjusting brightness (or resolution) of a display) of functions of the external electronic device which communicates with the electronic device, an application which operates in the external electronic device, or a service (e.g., a call service or a message service) provided from the external electronic device.

According to an embodiment, the application 1470 may include an application (e.g., the health card application of a mobile medical device) which is preset according to attributes of the external electronic device. According to an embodiment, the application 1470 may include an application received from the external electronic device. According to an embodiment, the application 1470 may include a preloaded application or a third party application which may be downloaded from a server. Names of the components of the program module 1410 according to various embodiments of the present disclosure may differ according to kinds of OSs.

According to various embodiments, at least part of the program module 1410 may be implemented with software, firmware, hardware, or at least two or more combinations thereof. At least part of the program module 1410 may be implemented (e.g., executed) by, for example, a processor (e.g., a processor 120 of FIG. 2). At least part of the program module 1410 may include, for example, a module, a program, a routine, sets of instructions, or a process, and the like for performing one or more functions.

The terminology “module” used herein may mean, for example, a unit including one of hardware, software, and firmware or two or more combinations thereof. The terminology “module” may be interchangeably used with, for example, terminologies “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

According to various embodiments of the present disclosure, at least part of a device (e.g., modules or the functions) or a method (e.g., operations) may be implemented with, for example, instructions stored in computer-readable storage media which have a program module. When the instructions are executed by a processor, one or more processors may perform functions corresponding to the instructions. The computer-readable storage media may be, for example, a memory.

The computer-readable storage media may include a hard disc, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a ROM, a random access memory (RAM), or a flash memory, and the like), and the like. Also, the program instructions may include not only mechanical codes compiled by a compiler but also high-level language codes which may be executed by a computer using an interpreter and the like. The above-mentioned hardware device may be configured to operate as one or more software modules to perform operations according to various embodiments of the present disclosure, and vice versa.

Modules or program modules according to various embodiments of the present disclosure may include at least one or more of the above-mentioned components, some of the above-mentioned components may be omitted, or other additional components may be further included. Operations executed by modules, program modules, or other components may be executed by a successive method, a parallel method, a repeated method, or a heuristic method. Also, some operations may be executed in a different order or may be omitted, and other operations may be added.

Embodiments of the present disclosure described and shown in the drawings are provided as examples to describe technical content and help understanding but do not limit the present disclosure. Accordingly, it should be interpreted that besides the embodiments listed herein, all modifications or modified forms derived based on the technical ideas of the present disclosure are included in the present disclosure as defined in the claims, and their equivalents.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

The control unit may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. In addition, an artisan understands and appreciates that a “processor” or “microprocessor” may be hardware in the claimed disclosure.

In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

While the present disclosure has been shown and described with reference to various embodiments thereof, it will be understood by those skilled in the art that various changes in form and details may be made therein without departing from the present disclosure as defined by the appended claims and their equivalents.

What is claimed is:

1. An electronic device, comprising:
a memory configured to store synchronization configuration information associated with function synchronization with an external electronic device; and
a processor, operatively connected to the memory and configured to:
transmit synchronization configuration information to a server, the synchronization configuration information generated according to settings, each indicating whether to synchronize at least one function of a plurality of functions, and
in response to detecting a change to at least one of the plurality of functions, transmit change information indicating the change to the server.

2. The electronic device of claim 1, wherein, when the change indicates alteration of a network setting of the electronic device, the processor is configured to transmit the change information comprising a function state value corresponding to the altered network setting to the server.

3. The electronic device of claim 2, wherein processor is configured to alter the network setting of the electronic device in response to detecting alteration of a detected location of the electronic device.

4. The electronic device of claim 1, wherein, when the change indicates alteration of a sleep setting of the electronic device, the processor is configured to transmit control information comprising information controlling at least one function of an external electronic device related to the sleep setting to the server.

5. The electronic device of claim 1, wherein the processor is configured to:
control a display to display a list of at least one external electronic device synchronizable to the electronic device.

6. The electronic device of claim 5, wherein the processor is configured to output a list of external electronic devices, wherein the list is generated to include one or more external electronic devices located within a predetermined distance from the electronic device.

7. The electronic device of claim 6, wherein the processor is configured to:
control a display images respectively selectable to add and delete the one or more external electronic devices from the generated list.

8. The electronic device of claim 1, wherein the processor is configured to:
control a display to display a function item list listing the plurality of functions, the function item list further including images selectable to activate or deactivate synchronization of particular functions from among the plurality of functions.

9. The electronic device of claim 1, wherein the processor is configured to:
in response to detecting an input requesting a change in a particular function of the electronic device, control the display to display an image selectable to verify whether to synchronize the change in the particular function with an external electronic device.

10. The electronic device of claim 9, wherein the processor is configured to:
in response to detecting selection of the image, transmit change information corresponding to the change in the particular function to the external electronic device.

11. A method in an electronic device, comprising:
storing, by memory, synchronization configuration information for implementing function synchronization with at least one external electronic device;
controlling the electronic device by a processor to transmit synchronization configuration information to a server, the synchronization configuration information generated according to settings, each indicating whether to synchronize at least one function of a plurality of functions; and
in response to detecting a change to at least one of the plurality of functions, transmitting change information indicating the change to the server.

12. The method of claim 11, wherein when the change indicates alteration of a network setting of the electronic device, the transmitted change information includes a function state value corresponding to the altered network setting.

13. The method of claim 12, wherein the network setting of the electronic device is altered in response to detecting alteration of a detected location of the electronic device.

14. The method of claim 11, wherein when the change indicates alteration of a sleep setting of the electronic device, the transmitted control information includes information controlling at least one function of an external electronic device related to the sleep setting to the server.

15. The method of claim 11, further comprising:
controlling a display to display a list of one or more external electronic devices synchronizable to the electronic device.

16. The method of claim 15, wherein the list is generated to include one or more external electronic devices located within a predetermined distance from the electronic device.

17. The method of claim 11, further comprising:
controlling a display to display images respectively selectable to add and delete the one or more external electronic devices from the generated list.

18. The method of claim 11, further comprising:
controlling a display to display a function item list listing the plurality of functions, the function item list further including images selectable to activate or deactivate synchronization of particular functions from among the plurality of functions.

19. The method of claim 11, further comprising:
in response to detecting an input requesting a change in a particular function of the electronic device, controlling a display to display an image selectable to verify whether to synchronize the change in the particular function with an external electronic device.

20. The method of claim 19, further comprising:
in response to detecting selection of the image, transmitting change information corresponding to the change in the particular function to the external electronic device.
